(19) United States
(12) Patent Application Publication
(10) Pub. No.: US 2026/0087925 A1
(43) Pub. Date: Mar. 26, 2026

(54) SYSTEM AND METHOD FOR PROVIDING DATA STREAM INFORMATION TO EMERGENCY RESPONSE DISPATCH

(71) Applicant: 3RD-I TECHNOLOGY INC., Chester, NJ (US)

(72) Inventor: Dillon Abend, Chester, NJ (US)

(21) Appl. No.: 19/405,028

(22) Filed: Dec. 1, 2025

Related U.S. Application Data
(63) Continuation-in-part of application No. 19/228,408, filed on Jun. 4, 2025.
(63) Continuation-in-part of application No. 19/177,266, filed on Apr. 11, 2025.
(63) Continuation-in-part of application No. 19/354,429, filed on Oct. 9, 2025.
(60) Provisional application No. 63/632,568, filed on Apr. 11, 2024.
(60) Provisional application No. 63/655,800, filed on Jun. 4, 2024.

(51) Int. Cl. G08B 25/10; G08B 25/00; H04N 7/18

(52) U.S. Cl. CPC G08B 25/10; G08B 25/007; H04N 7/181

(57) ABSTRACT

A system and method for providing information to emergency response dispatch including providing an application on the mobile communication device capable of receiving an emergency response request input and allowing a user to initiate a stream, and responsive to a first emergency response request input, transmitting an emergency data stream to be accessible to a remote dispatcher or monitoring center and connecting the user to emergency services dispatch, including providing the emergency data stream to emergency services dispatch to enable direct communication between the user and emergency services dispatch. The emergency data stream including a first video stream for video images an audio stream recording of environment audio stream recorded by the microphone of the mobile communication device; a stream of geolocation coordinates.

### CROSS-REFERENCE TO RELATED APPLICATIONS

This application is a continuation-in-part of U.S. patent application Ser. No. 19/228,408, filed Jun. 4, 2025, which claims the benefit of U.S. Provisional Application No. 63/655,800, filed Jun. 4, 2024 the disclosure of which is hereby incorporated herein by reference in its entirety, and which is also a continuation-in-part of U.S. patent application Ser. No. 19/177,266, filed Apr. 11, 2025, which claims the benefit of U.S. Provisional Application No. 63/632,568 filed Apr. 11, 2024, the disclosure of which is hereby incorporated herein by reference in its entirety. This application is also a continuation-in-part of U.S. patent application Ser. No. 19/354,429, filed Oct. 9, 2025, the disclosure of which is also hereby incorporated herein by reference in its entirety

### FIELD OF THE INVENTION

The present invention relates generally to social multimedia communication systems and, more particularly, to methods and apparatus for live streaming video, audio, and location data to emergency services dispatch and/or first responders, recording and archiving such streams, and providing interactive in-stream messaging, trip notifications, and emergency alerts.

The present invention also relates to the field of digital video recording and broadcasting, specifically a system and method enabling real-time video uploads with dual camera capabilities during recording. This system offers continuous accessibility through a single persistent link, allowing for immediate access to both short and long-duration videos. This innovation transforms the video-sharing space by enabling users to send and watch long-duration videos within seconds of a livestream or recording, eliminating the need to download and share large files, which is often time consuming and impractical for larger files and to watch a dual-camera livestream in real time.

The present invention also relates to the field of mobile safety systems and emergency alert technologies. More particularly, it relates to systems and methods for discreetly initiating and maintaining real-time, multimedia emergency broadcasts via mobile communication devices, enabling passive activation, secure transmission, and dispatcher access in high-risk or constrained environments.

### BACKGROUND OF THE INVENTION

Despite the proliferation of personal safety applications, many still rely on overt actions by users—such as dialing emergency services or verbally requesting help. These methods may escalate threats or be impossible in rapidly unfolding emergencies. Moreover, current systems lack contextual real-time data, such as visual/audio feeds or precise location tracking, and few provide reliable ways to notify emergency responders without detection.

There is a substantial unmet need for a system that enables users to discreetly activate a comprehensive emergency response mechanism-one that integrates live dual-camera video, continuous location updates, audio feeds, autonomous threat detection, and secure cloud storage-without the need for vocalization, app unlocking, or visible interaction, and to provide that data, including the video streams, map, location data, planned routes and actual routes to emergency services dispatch and/or first responders to assist and inform the emergency services response.

### SUMMARY OF THE INVENTION

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

In an embodiment, a method for providing information to emergency services dispatch from a user of a mobile communication device having at least one camera, a microphone, and a GPS receiver, may include: providing an application on the mobile communication device capable of receiving an emergency response request input and allowing a user to initiate a stream; and responsive to a first emergency response request input from the user, connecting the user to emergency services dispatch, including providing the emergency data stream to emergency services dispatch to enable direct communication between the user and emergency services dispatch. The emergency data stream may include a first video stream for video images recorded by a first camera of the at least one camera of the mobile communication device, an audio stream recording of environment audio stream recorded by the microphone of the mobile communication device, and a stream of geolocation coordinates from the GPS receiver of the mobile communication device.

In an embodiment, a method for providing information to emergency services dispatch from a user of a mobile communication device having a front-facing camera and a rear-facing camera, a microphone, and a GPS receiver, the method may include: providing an application on the mobile communication device capable of receiving an emergency response request input and allowing a user to initiate a trip-mode stream; and responsive to a first emergency response request input from the user, transmitting an emergency data stream to a remote dispatcher or monitoring center, and connecting the user to emergency services dispatch, including providing the emergency data stream to emergency services dispatch to enable direct communication between the user and emergency services dispatch. The emergency data stream may include, a first video stream for video images recorded by the front-facing camera of the mobile communication device, a second video stream for video images recorded by the rear-facing camera of the mobile communication device, an audio stream recording of environment audio stream recorded by the microphone of the mobile communication device, and a stream of geolocation coordinates from the GPS receiver of the mobile communication device.

In an embodiment, a system for managing an emergency response request for a user of a mobile communication device having at least one camera, a microphone, and a GPS receiver, may include: an application on the device capable of receiving an emergency services request input from the user and allowing the user to initiate a stream and a monitoring service capable of communicating with the application. The monitoring services may receive a first stream from the user comprising: a first video stream for video images recorded by the at least one camera of the mobile communication device, an audio stream recording of environment audio stream recorded by the microphone of the mobile communication device, and a stream of geolocation coordinates from the GPS receiver of the mobile communication device. Responsive to a first emergency services request input from the user during the first stream, connecting the user to emergency services dispatch to enable direct communication between the user and the emergency services dispatch and providing an emergency data stream to the emergency services dispatch, the emergency data stream comprising the first video stream, the audio stream, and the stream of geolocation coordinates.

### BRIEF DESCRIPTION OF THE DRAWINGS

The drawings set forth exemplary embodiments of the disclosed concepts and are not intended to be limiting in any way.

FIG. 1 illustrates a system architecture diagram for a safety system in accordance with the disclosed concepts.

FIG. 2 illustrates is a flow diagram of user input modalities and their respective activation triggers to initiate a potential emergency session.

FIG. 3 illustrates flow diagram for communication between the user and a remote dispatcher, for emergency escalation.

FIG. 4 is a flow diagram showing the broadcasting of the live streamed location informtion to viewers.

FIG. 5 illustrates a method for increasing a user's safety by providing an application allowing for the initiation of potential emergency sessions.

FIG. 6 illustrates a system diagram for a system for rider safety in accordance with the disclosed concepts.

FIG. 7 illustrates a user device that may be used with the systems and methods of FIGS. 1-6.

FIG. 8 illustrates a graphical user interface layout for a dashboard in accordance with the disclosed concepts.

FIG. 9 illustrates a block diagram of a system architecture in accordance with the disclosed concepts.

FIG. 10 illustrates flow diagram for a method for distributing a live broadcast session in accordance with the disclosed concepts.

FIG. 11 illustrates a flow diagram for a method for initiating a trip mode broadcast in accordance with the disclosed concepts.

FIG. 12 illustrates a flow diagram for a method for initiating an emergency alert in accordance with the disclosed concepts.

FIG. 13 illustrates a flow diagram for a system for live broadcasting and archival in accordance with the disclosed concepts.

FIG. 14 illustrates a flow diagram for a method for continuous video recording and live broadcasting.

FIG. 15 illustrates, a system diagram of a representative system architecture including client devices, an authorization/consent service, an anomaly/context engine, a dispatch orchestration service, and a communication gateway.

FIG. 16 illustrates a flowchart for a method for triggering an emergency on behalf of a user of the on-behalf dispatch method showing trigger reception, authority verification, location/address resolution, dispatch payload transmission, and group communication creation.

FIG. 17 illustrates a client application streaming screen allowing a contact to trigger an emergency response on behalf of a client user in accordance with the disclosed concepts.

FIG. 18 illustrates a client application contacts screen allowing a contact to trigger an emergency response on behalf of a client user in accordance with the disclosed concepts.

FIG. 19 illustrates a client application contacts screen allowing a contact to trigger an emergency response on behalf of a client user in accordance with the disclosed concepts.

FIG. 20 illustrates a streaming map-view screen allowing a contact to trigger an emergency response on behalf of a client user in accordance with the disclosed concepts.

FIG. 21 illustrates an exemplary group communication screen in accordance with the disclosed concepts.

FIG. 22 illustrates a trip streaming view of a mobile application in accordance with the disclosed concepts.

FIG. 23 illustrates a desktop application view of a trip stream in accordance with the disclosed concepts.

FIG. 24 illustrates a desktop application view of a trip stream in accordance with the disclosed concepts.

FIG. 25 illustrates a client application contacts screen allowing a contact to trigger an emergency response on behalf of a client user in accordance with the disclosed concepts.

FIG. 26 illustrates a client application contacts screen allowing a contact to confirm an address for an emergency response on behalf of a client user in accordance with the disclosed concepts.

FIG. 27 illustrates an address selection confirmation screen in accordance with the disclosed concepts.

FIG. 28 illustrates an address selection confirmation screen in accordance with the disclosed concepts.

FIG. 29A illustrates a display of a dual-camera stream with one stream above the other on a mobile device.

FIG. 29B illustrates a display of a dual-camera stream with the streams side by side.

FIGS. 29C and 29D illustrate a display of a dual camera stream picture-in-picture.

### DETAILED DESCRIPTION OF THE INVENTION

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In an embodiment, a method for providing information to emergency services dispatch from a user of a mobile communication device having at least one camera, a microphone, and a GPS receiver, may include: providing an application on the mobile communication device capable of receiving an emergency response request input and allowing a user to initiate a stream; and responsive to a first emergency response request input from the user, connecting the user to emergency services dispatch, including providing the emergency data stream to emergency services dispatch to enable direct communication between the user and emergency services dispatch. The emergency data stream may include a first video stream for video images recorded by a first camera of the at least one camera of the mobile communication device, an audio stream recording of environment audio stream recorded by the microphone of the mobile communication device, and a stream of geolocation coordinates from the GPS receiver of the mobile communication device.

In an embodiment, a method for providing information to emergency services dispatch from a user of a mobile communication device having a front-facing camera and a rear-facing camera, a microphone, and a GPS receiver, the method may include: providing an application on the mobile communication device capable of receiving an emergency response request input and allowing a user to initiate a trip-mode stream; and responsive to a first emergency response request input from the user, transmitting an emergency data stream to a remote dispatcher or monitoring center, and connecting the user to emergency services dispatch, including providing the emergency data stream to emergency services dispatch to enable direct communication between the user and emergency services dispatch. The emergency data stream may include, a first video stream for video images recorded by the front-facing camera of the mobile communication device, a second video stream for video images recorded by the rear-facing camera of the mobile communication device, an audio stream recording of environment audio stream recorded by the microphone of the mobile communication device, and a stream of geolocation coordinates from the GPS receiver of the mobile communication device.

In certain embodiments, the emergency data stream may further include trip information, including a destination, a planned route, and an actual route, wherein the actual route comprises at least some of the stream of geolocation coordinates. In certain embodiments the emergency data stream may further include the user's emergency medical information packet. In certain embodiments, the emergency data stream may further include the user's vehicle information. In certain embodiments, the vehicle information may include a vehicle make, vehicle model or information streamed from the vehicle. In certain embodiments, the method of claim 1 may further include providing the user with a location confirmation screen where they can provide updated current location information. In certain embodiments, the emergency data stream may further include a ride share packet. In certain embodiments, the ride share packet may include information selected from the group of the driver identity, driver's license number, car make, car model and license plate. In certain embodiments, the emergency data stream may further include a companion information packet. In certain embodiments, the companion information packet may include an identity and medical packet for a contact that is on the trip with the user.

In an embodiment, a system for managing an emergency response request for a user of a mobile communication device having at least one camera, a microphone, and a GPS receiver, may include: an application on the device capable of receiving an emergency services request input from the user and allowing the user to initiate a stream and a monitoring service capable of communicating with the application. The monitoring services may receive a first stream from the user comprising: a first video stream for video images recorded by the at least one camera of the mobile communication device, an audio stream recording of environment audio stream recorded by the microphone of the mobile communication device, and a stream of geolocation coordinates from the GPS receiver of the mobile communication device. Responsive to a first emergency services request input from the user during the first stream, connecting the user to emergency services dispatch to enable direct communication between the user and the emergency services dispatch and providing an emergency data stream to the emergency services dispatch, the emergency data stream comprising the first video stream, the audio stream, and the stream of geolocation coordinates.

In certain embodiments, the first stream may be a trip-mode stream and the emergency data stream may further include trip information, including a destination, a planned route, and an actual route, wherein the actual route comprises the stream of geolocation coordinates. In certain embodiments, the emergency data stream may further include the user's emergency medical information packet. In certain embodiments, the emergency data stream may further include the user's vehicle information. In certain embodiments, the vehicle information may include a vehicle make, vehicle model, or information streamed from the vehicle. In certain embodiments, the application may further provide the user with a location confirmation screen where they can provide updated current location information. In certain embodiments, the emergency data stream may further include a ride share packet having information selected from the group of the driver identity, driver's license number, car make, car model and license plate. In certain embodiments, the first stream may include a second video stream, such that the first video stream is captured by a forward-facing camera of the at least one camera on the mobile communications device and the second video stream is captured by a rear-facing camera of the at least one camera on the mobile communications device. In certain embodiments, the emergency data stream may further include a companion information packet. In certain embodiments, the companion information packet may include an identity and medical packet for a contact that is on the trip with the user.

In an embodiment, a method for broadcasting live multimedia to predefined social groups (squads), may include selecting one or more squads in a client application, where each of the squads may include one or more members, initiating a live broadcast session capturing and transmitting a first and second video streams from a first and second camera and an environmental audio stream, initiating a push notification to members of the selected one or more squads, and upon termination of the live broadcast session, archiving the live broadcast session. The archiving of the live broadcast session may include storing a recording of the video and audio, a text transcript, and an AI-generated summary.

In certain embodiments the first and second cameras may be front-facing and rear-facing cameras, and the first and second video streams are captured simultaneously. In certain embodiments, the method may further include engaging trip mode, which may include specifying current location and a destination, computing an estimated time of arrival, transmitting a GPS location stream and corresponding time stamp stream as part of the live broadcast session, notifying the selected squads of trip start and the estimated time of arrival, streaming real-time trip updates showing an actual route made from the GPS location stream as part of the live broadcast session, issuing an arrival notification upon reaching the destination reach. The archiving the live broadcast session may further include archiving a trip recording, which may include the planned route, the actual route, the gps location stream and corresponding time stamp stream. The selected squads may be provided access to the archived broadcast session, including the trip recording.

In certain embodiments, the method may further include issuing an emergency alert during the session that dispatches a high-priority notification with live location and stream access links to the selected squads. In certain embodiments, the method may further include generating and associating a persistent access link with the live broadcast such that during the live broadcast the persistent access link provides access to the live broadcast, including the first and second video streams, the environmental audio stream, and after the live broadcast session, the persistent access link provides access to the archived broadcast, including the recording of the video streams and audio stream, the text transcript, and the AI-generated summary. In certain embodiments, the method may further include generating and associating a persistent access link with the live broadcast session such that during the live broadcast the persistent access link provides access to the live broadcast session, including the first and second video streams, the environmental audio stream, the planned route, the actual route, the GPS location stream and corresponding time stamp stream, and after the broadcast session, the persistent access link provides access to the archived broadcast, including the recordings of the first and second video streams and the audio stream, the planned route and the actual route, the GPS location stream and corresponding time stamp stream . . . . In certain embodiments, the persistent access link may present the first and second video streams in a dual-camera split-screen format.

In certain embodiments, the method may further include a messaging interface that allows real-time communication between the broadcaster and squad members. In certain embodiments, the method may further include the allowing viewers to react or respond via the messaging interface during the live stream. In certain embodiments the first and second video streams may be encoded using a compression algorithm selected from the group consisting of H.264, H.265, or VP9. In certain embodiments, the method may further include receiving confirmation when the members of the selected squads join the live broadcast session, and providing a user interface button for initiating a secondary nudge alert to the members of the selected squad who have not joined the broadcast session. In certain embodiments, the method may further include receiving confirmation when the members of the selected squads join the live broadcast session, and issuing a secondary nudge alert to the members of the selected squad who do not join within a configurable time threshold. In certain embodiments, the persistent access link may include an optional expiration timestamp or access token. In certain embodiments, the application may further be configured to record timestamp metadata during the video session. In certain embodiments, the method may further include generating a summarized video highlight reel using artificial intelligence.

In certain embodiments, the access permissions for the persistent link may be managed through a user account. In certain embodiments, a viewer interface may be provided with the persistent access link allows switching between single and dual-camera viewing modes. In certain embodiments, the method may further include using edge computing or local caching to reduce latency in long-duration video playback. In certain embodiments, the dual video streams may be displayed side-by-side in a split-screen format on a web or mobile interface. In certain embodiments, the first and second video streams may be displayed in picture-in-picture format on a web or mobile interface.

In an embodiment, a system for social live broadcasting, may include a client application installed on a user device, the client application configured to capture dual-camera video, audio, and GPS location; a backend server configured to manage session credentials, direct media streams, generate speech-to-text transcripts and AI summaries, and store session data; a notification service configured to send push, SMS, and in-app alerts for the initiation of a live broadcast, nudge alerts, trip alerts, arrival alerts, and emergency events; and a data store for persisting recorded media, transcripts, summaries, and route data.

In an embodiment, a non-transitory medium may be provided with a set of instructions that when executed by a processor, cause the processor to perform any of the methods described above.

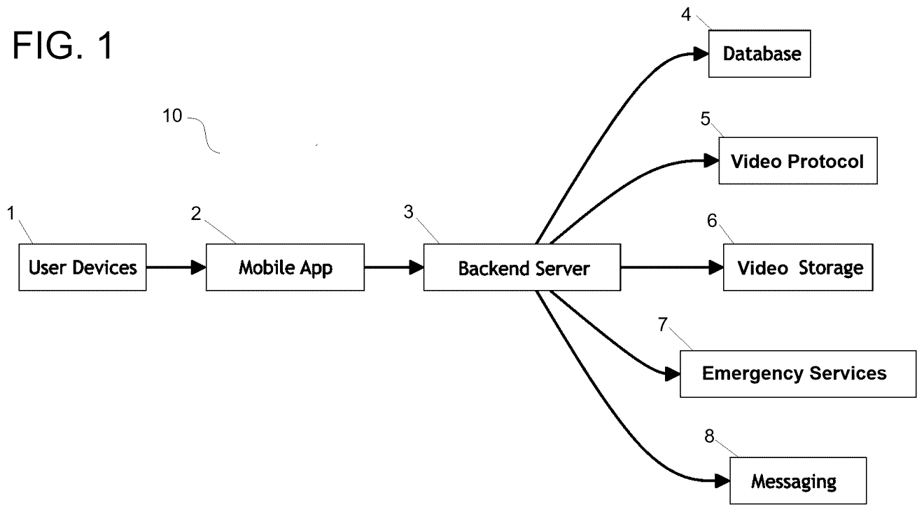

One use of the disclosed concepts relates to the personal safety space. FIG. 1 illustrates a system architecture diagram for a system for social broadcasting safety 10 comprising a mobile application 2 designed to run on user device 1, and backend server 3. The user device 1 may be any suitable device, preferably having both a forward facing camera and a rearward facing camera, a microphone, and a GPS receiver. The mobile application 2, as described in greater detail below, may be capable of communicating with the backend server to initiate potential emergency sessions, escalations to an emergency response request, enable communications, facilitate simultaneous recording of video streams from both the forward-facing and rearward-facing cameras on the user device, and facilitate communication recording and transmitting video streams, an audio stream captured by the user device 1's microphone, a the user device's GPS location data in real time, for recording and/or processing by the back end server. 3

The backend server, as described in greater detail below may facilitate communication between the user and a remote dispatcher/monitoring center, requests for emergency response by authorities that are local to the user, and coordination of the delivery of the data streams recorded by the user the remote dispatcher/monitoring center, local authorities, and/or to the proper third party viewers. The backend server 3 may communicate with, or control communications with a database 4, a video protocol 5, a video storage service 6, an emergency services provider 7, and a messaging system 8 The database 4 may be any suitable database system known in the art or to be developed that may be used for storage of all relevant data received during such incidents, including, but not limited to, user information, such as name, number, description, photographs, address, etc. user preferences, such as escalation thresholds and logic, time-to-escalate rules, non-response triggers, escalation to professional monitoring services, viewer lists, timing settings, etc., session information, including the start time, all inputs received from the user, and the timing related to same, all responses and notifications sent to the user during the session, and any other information that may be useful.

The video protocol 5 may be any suitable video protocol known in the art or to be developed that can be used to record, encode, compress and transmit a live-stream video feed, including but not limited to the Agora Video SDK. The video protocol may be available to both the mobile application 2 and the backend server 3, and the backend server 3 may control pushing updates to the video protocol 5 to the mobile application 2. The video storage service 6 may be any suitable storage location known in the art or to be developed, that can store and make available both the live stream data captured during the sessions, and the complete copies of same kept after the sessions have been completed. The emergency services protocol 7 may be a remote dispatcher or monitoring service, or a protocol for communicating to same, such as the NoonLight API, RapidSoS, or any other such protocol or system known in the art or to be developed. It may provide services for communicating with the user during potential emergency sessions, and/or during escalations to an emergency response request. The messaging system 8 may be any suitable messaging system, including but not limited to Firebase Cloud messaging, SMS messaging, and any other messaging systems known in the art or to be developed. This messaging system may be used to provide the user feedback relating to the success of certain actions, such as initiating a potential emergency session, escalating such a session to a request for emergency response, status updates regarding the stages of an emergency response, communication between the user and a remote dispatcher/monitoring center, communications between law enforcement and the user, and any other messages that may be needed.

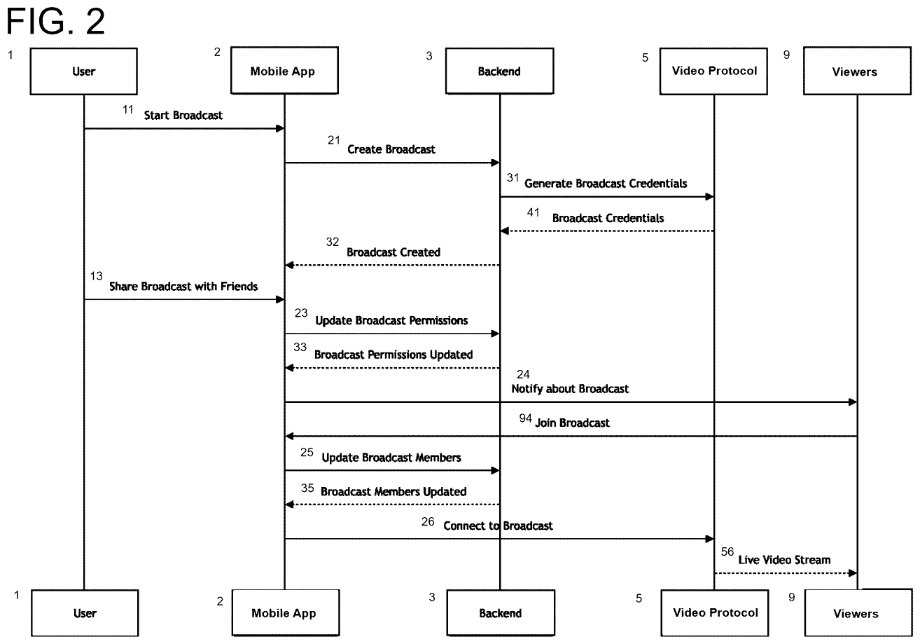

FIG. 2 illustrates is a flow diagram of user input modalities and their respective activation triggers to initiate a potential emergency session in a system 10 in accordance with the disclosed concepts. A user may use their user device 1 to initiate a request to initiate a potential emergency session and start a broadcast 11 on the mobile application 2. The request to initiate a potential emergency session/start a broadcast 11 may be made through any suitable input known in the art or to be developed, including but not limited to activation via widget taps on the mobile application 2, shake gestures employed on the user device 1, spoken safe words captured by the microphone, particular button combinations (these may be hardware, such as hitting the volume buttons in a particular sequence, or software, such as “dialing” a number on a touch screen that looks like a phone dialing screen), or peripheral device/external accessories such as wearable devices with a BlueTooth or other suitable connection to the user device that can send a signal to the application to initiate a potential emergency session/start a broadcast 11 when a button is pressed or other input is made on the wearable device. The mobile application may have a user interface that mimics the user device's normal phone screen, a texting application, another application, such as a game or video streaming application, in order to allow the user to discreetly provide activation input if they are in potentially dangerous circumstances. For example, the mobile application may provide visual or haptic feedback to the user confirming successful initiation of a potential emergency session and transmission of emergency data streams to a remote dispatcher or monitoring center, without exposing the activity to observers. Upon receiving initiating input, the mobile application 2 may create a broadcast request 21 from the backend server 3. The mobile application may further activate the user device's forward facing and rearward facing cameras, and simultaneously begin recording a video stream on each. The mobile application may further begin recording one or more audio streams using its microphones, either separately or integrating into one or both video streams, and may further begin recording user device geo-location data from the device's GPS receiver. The mobile application may periodically packetize and transmit emergency streaming data, including but not limited to the front and rear video streams, the audio stream and the stream of GPS geo-location data. Other data may be included in the emergency streaming data, including time stamps, and information about how the phone is being held, heart rate and other biometric data provided by Bluetooth devices, such as a smart watch or a heart rate monitor. Once the potential emergency session is initiated, it may be maintained by the mobile application 2 until the user enters a particular input, such as a security pin, so that other people, such as an aggressor, cannot end it. Similarly, the mobile application may continue to run in the background, even when minimized, continuing to transmit the video, audio and location data when the mobile application 2 is not visible on the user device's 1 display. The mobile application 2 may also run in a semi-minimized state, such as a picture-in-picture format, allowing the user to continue to use the application in a portion of the user device display, while the device can be used normally outside of that picture-in-picture window.

When a request to create a broadcast 21 is received by the backend server 3, It may generate a request for broadcast credentials 31 using a video protocol 5, which may provide the backend server 3 with broadcast credentials 41. Upon successfully receiving same, the backend server 3 may notify the mobile application that the broadcast has been received. The mobile application 2 may provide the emergency streaming data to the backend server 3 for distribution and processing, or it may directly provide the emergency streaming data to the video storage 6 location, where it may be accessible by the backend server 3. The backend server 3 provides the mobile application with a broadcast created notification 32 that may be communicated to the user through visual, haptic, or other suitable feedback, such as vibrations. While auditory feedback may be used with the disclosed concepts, one of the features of system 10 is that it can be implemented to work completely silently and discreetly. Audio feedback may be heard and recognized by a belligerent causing dangerous circumstances, but haptic and visual feedback can be designed to mimic the ordinary usage of the user device, such as receiving normal text messages or application notifications. The backend server 3 may further provide processing on the emergency streaming data. For example, it may monitor and use voice recognition software to detect additional key words in the audio stream, which can be used for escalating a potential emergency session into an emergency response request, or for deescalating or deactivating such a request or session. Additionally, the backend server, or a separate processing module or resource, may be provided with an AI model trained on processing emergency streaming data, and to recognize dangerous circumstances from either video stream, or from the audio stream, or from a combination of both. Such an AI model could be trained from a database of past incidents where video or audio feeds are available. Any suitable method of training such an AI model, and any suitable AI model known in the art or to be developed may be used

A user may further initiate an input to share the broadcast with friends 13 on the application. In doing so, they may select the friends with which to share the broadcast, or they may have a pre-selected set of friends identified in their user preferences on the mobile application 2. Upon a request to share the broadcast with friends 13, the mobile application 2 passes the request along to the backend server, along with any updated broadcast permissions 23 provided with a request, such as a user list of friends to receive the broadcast notification. Accordingly, the mobile application 2 may allow the user to send a ‘nudge’ notification to specific contacts to encourage them to join the emergency stream. The backend server 3 may then communicate a broadcast permission updated 33 success message to the mobile application 2, which may notify the user of same through visual, haptic, or other feedback. The backend server may further generate notifications to inform the desired viewers 9 of the broadcast of the user's emergency stream. This may include sending a mobile application 2 message notifying the viewer about the broadcast 24, or it may involve sending an SMS message to the viewer with a link to open the user's broadcast emergency data streams either with the mobile application 2 or via a website. Regardless of how the notification is made, the viewer 9 may join the broadcast 94, by following the link to the mobile application 2 or website where the stream is made available. The mobile application 2 may provide the back end server with an update broadcast members notification 25 indicating that the viewer 9 has commenced watching the user's broadcast. The backend server may then provide the viewer 9's mobile application 2 with a broadcast members updated notification 35 indicating that they have successfully joined the broadcast, and then connect the viewer 9 to the broadcast 26 using the video protocol 5, which may accessing the stream from the video storage 6 or a mirror for same which will provide the live video stream 56 to the viewers 9. The mobile application 2 may allow the viewers to communicate with the user via the messaging system 8, or the viewers 9 may reach out to the user via phone or text communications.

The mobile application 2 may be implemented to poll device connectivity, checking to see whether the user device it has sufficient connection and bandwidth to communicate with the back end server and transmit the emergency data streams. If bandwidth or connectivity becomes an issue, the mobile application may adjust the encoding of the video and audio streams to require less data (or use more data when bandwidth is not at issue), and may further initiate fallback SMS messaging when connectivity is interrupted. The SMS messages may continue to contain location data, and may be used to communicate between the mobile application 2 and the backend server 3, as well as to allow the user to communicate with the emergency services protocol 7 or local dispatch 75.

The mobile application may allow the user to set a variety of user preferences that govern how the application works and who gets notified of potential emergency sessions and requests for emergency response. Such user preferences may include, without limitation, the following: lists of contacts to be notified when a potential emergency session is initiated an the manner of notification to be sent to those contacts (“nudge” notifications, alarms, in-app messages, SMS notifications, etc.); lists of contacts to be notified when an emergency response request is made, and the manner of notification; escalation thresholds and logic such as whether the user should initiate escalations or if escalations should be initiated if the user stops responding or using the mobile application, the frequency with which the mobile application should present response check prompts, time-to-escalate rules setting the timing for escalation due to non-responsiveness or based on user input (for example the user may set an emergency response to require two button presses within a one second window, non-response triggers (such as how many missed status checks should be allowed before escalating to an emergency response request, and the timing between such checks after a failed response), and preferences on the circumstances for escalation to professional monitoring services and what services should be notified.

The mobile application 2 may be linked to a ride-hailing or transportation service platform, such as Uber, Lyft, or a taxi company, or similar services. The mobile application 2 or the backend server 3 may be implemented to initiate potential emergency session automatically if the user deviates from a predetermined route or cancels a destination unexpectedly. In such circumstances the mobile application may prompt the user with a status check, and may initiate the session if the user does not respond. The backend server 3 may also initiate a session using the driver's mobile application 2 on the driver's mobile device 3. Importantly, this system can also be used to increase driver safety from unruly passengers.

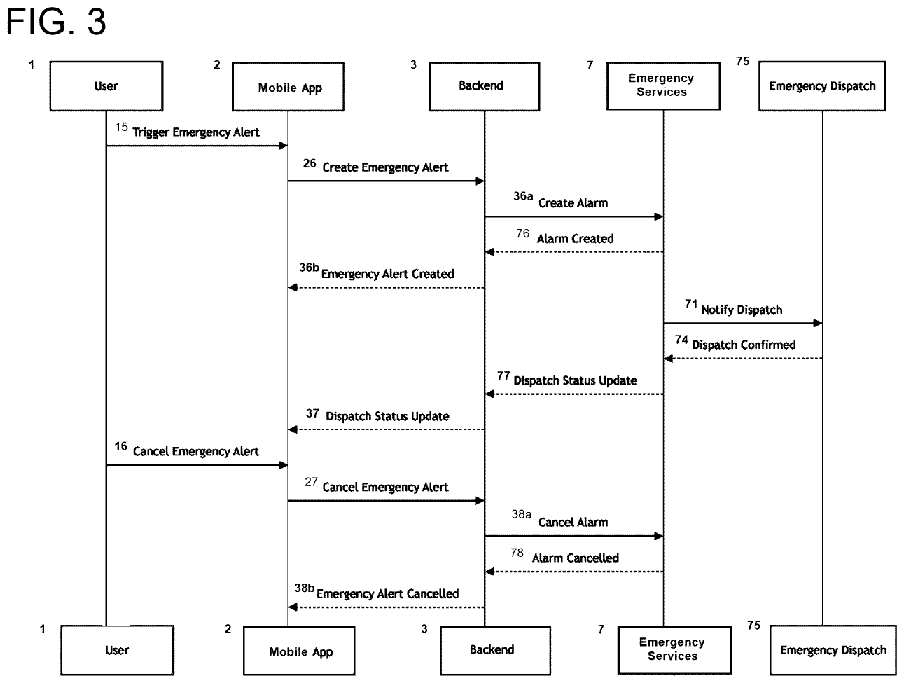

FIG. 3 illustrates flow diagram for communication between the user and a remote dispatcher, for emergency escalation using the system 10. A user may use their user device 1 to trigger an emergency alert 15. Triggering an emergency alert 15 may happen in a variety of ways. The user may manually trigger the emergency alert 15 by hitting a widget or a button on the application. Alternatively, the user may say a safe word set to trigger the emergency alert 15. The user may make a gesture with the user device 1, or hit a button or other input on a wearable device that is in BlueTooth, or other communication with the user device 1. Other methods of triggering an emergency alert may not require the user's input. For example, an AI model, as described above may be trained to detect dangerous circumstances from a video or audio feed, and may be monitoring a live stream broadcast either on the backend server 3 or on the user's device 1 via the mobile application 2. The mobile application 2 may be set to monitor a biometric reading, such as the user's heart rate, and may automatically trigger an emergency response rate if the heart rate spikes, drops below a threshold, or displays an irregular rhythm. Importantly, such triggers may occur even when a potential emergency session is not active and may lead to activation of both a potential emergency session and a request for emergency response at the same time. However triggered, the mobile application 2 may create an emergency alert 26, requesting an emergency response from local authorities. The backend server 3, upon receiving same, may create an alarm 36a and communicate the alarm to an emergency services service or protocol, such as a remote dispatcher or monitoring service, or using a protocol like the NoonLight API. The alarm may be passed along to an administrator at the remote dispatcher/monitoring service, who may locate the appropriate authorities and make an emergency response request to them. Alternatively this may be handled automatically and programmatically, and the emergency services protocol 7 may directly notify dispatch 71 by sending a notification and the relevant evidence, which may include the emergency data stream, and any collected metadata, a transcript of the audio stream prepared via a text-to-speech program, and/or a summary of same generated by a trained large language model AI. The emergency services protocol or service 7 may confirm that an alarm has been created 76 to the backend server 3, which in turn ay notify the mobile application 2 that the emergency alert has been created 36b, which may then provide feedback to the user's device via visual, haptic or other suitable feedback. The emergency dispatch service may communicate via the emergency services protocol 7 or may directly communicate with the user via the messaging system 8, an may provide a dispatch confirmed message 74 and/or periodic updates on the status of the emergency response. Dispatch status updates 77 may be provided by the emergency services protocol 7 to the backend server 3, which may then provide a dispatch status update 37 to the mobile application, which may provide visual, haptic, or other suitable feedback to the user's device 1. The create an alarm notification 36a, may also be passed along to selected viewers 9 to notify them of the situation an give them access to the emergency data streams. Their mobile application may receive such a notification and issue a high-priority sound notification using a mobile device's critical alert entitlement framework that bypasses device mute and do-not-disturb states. This alarm notification may include a link to live stream data and user location.

The user may also cancel an emergency alert if they feel the danger has passed, by touching a widget on the screen of the user's user device, saying a keyword/safe word, or through any other suitable method known in the art or to be developed. The mobile application 2 then generates a cancel emergency alert 27 which is sent to the backend server 3. The backend server may then issue a cancel alarm 38a for the emergency services protocol or service 7, which may then notify dispatch 71 that the alarm has been cancelled. Emergency dispatch 75 may then take steps to cancel the emergency response, and issue a dispatch confirm 74, to the emergency services protocol or service 7, which may confirm with an alarm cancelled notification 78 to the backend server 3. The backend server 3 may then issue an emergency alert cancelled notification 38b to the mobile application 2, which can notify the user via visual, haptic, or other suitable feedback.

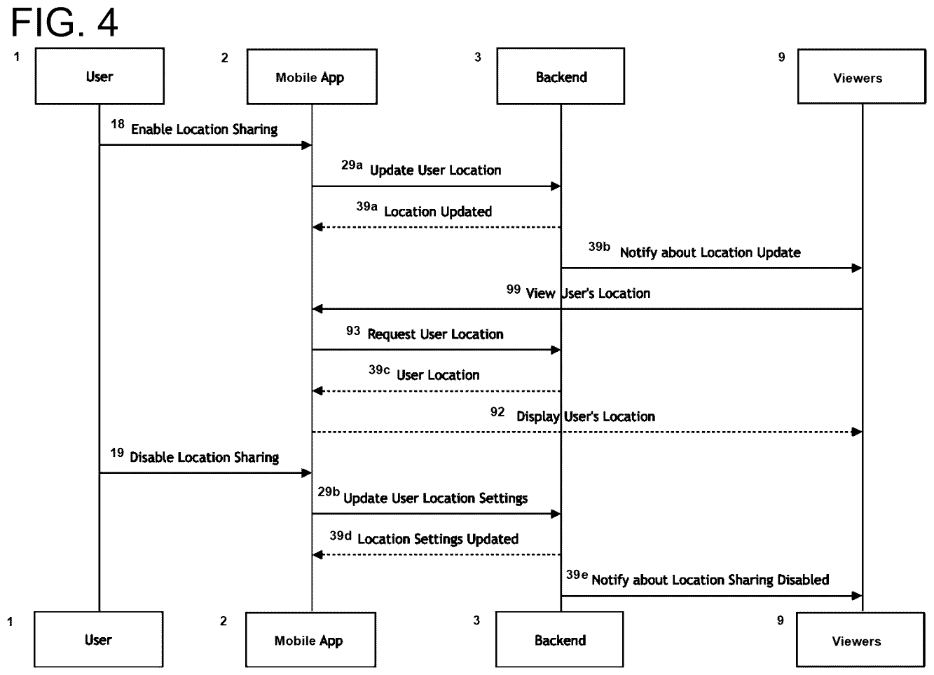

FIG. 4 is a flow diagram showing the broadcasting of the live streamed location information to viewers 9 by the system 10. The location sharing may be used as part of the potential emergency session and/or emergency response methods, described above, or it could be used independently of same. A user may enable location sharing 18 through any of input methods discussed herein, including tapping a widget on the mobile application, using a key word that is detected through a speech to text feature in the application 2, making specific gestures with the user device 1, or hitting a button or other input on a wearable BlueTooth or other wireless device. When location sharing is enabled the mobile application 2 may periodically update the user's location 29a with the backend server 3. The backend server, in turn, may confirm that the location is updated 39a, and may further notify selected viewers 9 about the location update 39b. The location update notification 39b may be through the mobile application 2 on the user's device 1, or may be through SMS or another suitable communication methodology. The viewers 9 may use the mobile application 2 on their user device 1, or may be directed to a website where they can generate a view the user's location 99 request, which may cause their mobile application to request the user's location 93 from the backend server 3 which may then send the user's location 39c to the viewer's 9 mobile application 2, which can then display the user's location 92 by displaying a map with the location highlighted, or through any other methodology for same known in the art or to be developed.

Similarly, a user may disable location sharing 19 by providing input to the mobile application using any of the input methodologies discussed above. This may be done globally for all viewers 9, or on a viewer 9 by viewer 9 basis. The mobile application 2, may generate an update user location settings notification 29b for the backend server instructing the backend to cease further communications relating to the user's location, The backend may confirm the location settings as updated 39d, and may further notify any affected viewers that the user has ceased location sharing 39e.

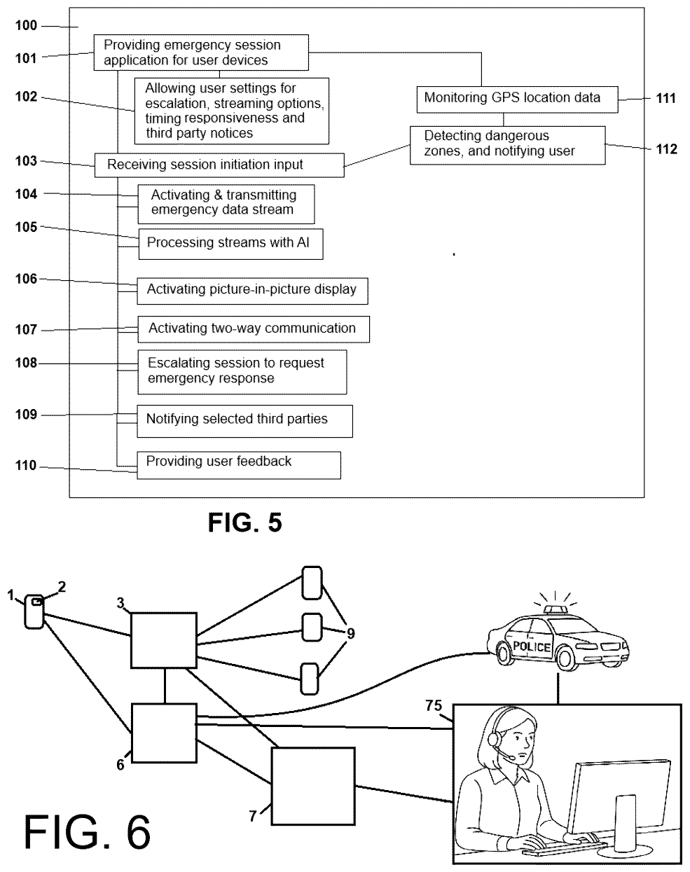

FIG. 5 illustrates a flow diagram for a method for discreetly improving a user's safety 100. The method may include providing an application that allows initiation of potential emergency sessions 101, that can receive session initiation input 103, and may include a passive monitoring feature 111. The application may allow the user a variety of user settings 102, which can allow the user to set circumstances for escalation of a potential emergency session into a request for emergency services, including but not limited to the user's failure to respond to certain prompts, the use of a panic button on the graphical user interface, the use of certain motions or gestures or facial expressions using the rear-facing camera on the mobile device. Other settings may include streaming options, such as what data should be streamed, and whether off-plan data transmission options should used, and when they should be used, the timing settings for when the user should be expected to respond to a prompt, or confirm the initiation of a session, or the like, and the identification of third parties who should receive notices when a potential emergency session or emergency response request is initiated and which data streams those third parties should be given access to.

When the application receives session initiation input 103, it may activate and transit emergency data streams, including but not limited to a first front-facing camera video stream, a second rear-facing camera video stream, an audio stream of environmental audio captured by the mobile device's microphone, and GPS location data from the mobile device's GPS receiver. Other data, such as transcription of the audio via text-to-speech or meta data about time stamps, biometric data (such as heart rate), or device orientation may also be included. The application may also initiate AI review of the emergency data streams on an on-device or remote dispatcher/monitoring center AI model trained to process audio and/or video streams to identify dangerous circumstances. When the AI detects dangerous circumstances it may directly initiate an emergency response from authorities local to the user's location, or it may escalate the potential emergency session to a human for review and authorization of an emergency response request from local authorities.

During a potential emergency session, the device may display application in a semi-minimized picture-in-picture format 106. This may allow for the user to continue to use the phone normally, while also being able to receive notifications and use the mobile application 2. The mobile application would function normally in the smaller window that it is given, and the phone would operate normally when the user manipulates it outside of the application's window. During a potential emergency session, the application may activate two-way communication between the user and the remote dispatcher/monitoring center. During a potential emergency session, the application may provide an interface option to escalate the potential emergency session into a request for emergency response 108 from local authorities. It may do so in response to key words detected in the audio stream, specific gestures with the mobile device, or by the user hitting a panic button.

During a potential emergency session, or when the session is escalated to a request for emergency response, the application may initiate notifications to selected third parties 109, pursuant to the users settings. During a potential emergency session, the application may further provide feedback to the user 110 in the form of a visual cue or haptic feedback to indicate that the potential emergency session has successfully been initiated, to confirm that the data streams are successfully being transmitted, and/or to confirm that a request for emergency response has been successfully initiated.

Passive GPS monitoring 111 may optionally be engaged to detect when the user may be in danger and should consider preemptively activating a potential emergency session. For example, the application may prompt the user when the user enters a GPS neighborhood or zone 112, or the settings may allow the application to automatically initiate a potential emergency session. Such areas may be identified by the user, or by the remote dispatcher/monitoring station, which may set up geo-fenced zones known to be dangerous, and where extra caution should be used. The mobile application 2 may automatically also prompt the user with a pre-alert notification when a vehicular or a pedestrian motion is detected exceeding a predefined threshold, offering the user one-tap access to emergency activation or live streaming, or automatically beginning the session if the user fails to respond, or if other conditions are met (the unusual speed continues for a predefined time, a safe word is detected, etc.)

FIG. 6 illustrates a system for rider safety 10. The system 10 may include a user device 1 on which a mobile application 2 is installed, a backend server 3/monitoring station, a video storage service 6, an emergency services protocol service 7, a local dispatcher 75 and first responders. The mobile application in FIG. 6 is shown in picture-in-picture mode, occupying only a portion of the user device's 1 display, allowing the user device to function normally around the mobile application frame, while allowing the user to use the mobile application and receive notifications on it. The mobile application 2, or client application, allows the user to initiate potential emergency sessions, escalate those into requests for emergency response, transmit emergency streaming data, including video from the front-facing camera, rear-facing camera, an audio stream of audio picked up by the user device's 1 microphone, and a geo-location data stream from the user device's GPS receiver, set user preferences, and perform any of the methods discussed above in greater detail for the mobile application 2. The backend server may act as a monitoring station and may coordinate communication between the mobile application 2, the video storage system 6 and the emergency services protocol service 7, as described above. It may also manage communication to mobile applications on viewer devices 2 and/or provide links to viewer devices through SMS, email or other communication methods to provide them with access to the live streaming data from the user device's 1 mobile application 2 during a potential emergency session and/or during escalation to an emergency response request. It may also perform any of the methods disclosed above for the backend server 3. The video storage service 6 may store and make available for distribution the live stream data, and may store a copy of the full stream once the live stream has finished. The emergency services protocol service 7 may provide an administrator to communicate and monitor the user's situation, handle requests for escalating into a request for emergency response from local authorities, and handle the actual communications to the local authority emergency dispatch 75. Persons of skill in the art will recognize that the disclosed concepts can be implemented in a myriad of ways, and some of these systems may be combined or systems may be separated into separate modules to accomplish the goals of the disclosed concepts within the contemplated scope of same.

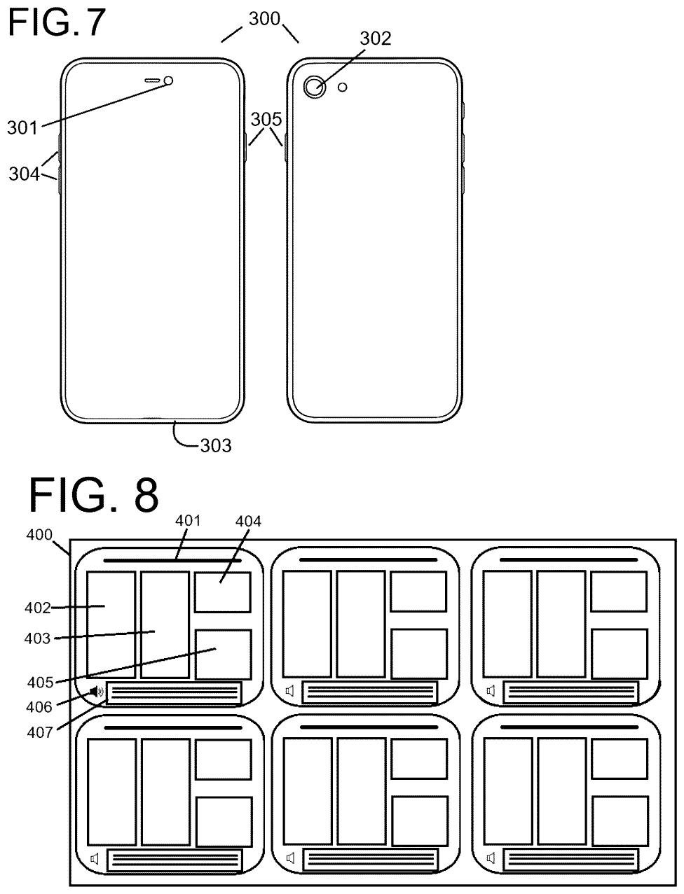

FIG. 7 illustrates a user device 1, 300 that may be used with the systems and methods discussed above. The user device may have a forward facing camera 301, a rear-facing camera 303, one or more microphones 303, hardware buttons, like the volume buttons 304, and a power button 305. It may have a GPS receiver, and hardware and software that allow it to run applications, such as the mobile application 2 described above, and communicate with other computers, such as the backend server 3, via the Internet or a VPN. It may further be provided with BlueTooth and other wireless communications protocols to allow it to connect to external accessories/peripheral devices, such as heart rate monitors, smart watches, emergency buttons, and other such devices, all of which can then be used in accordance with the methods and systems described above.

FIG. 8 illustrates a monitoring system dashboard user interface 400. The dashboard may include a plurality of potential emergency sessions 401. Each may include identifying information 402, a first video stream 403, a second video stream 404, an additional information window 405, a sound control 406 and a message history 407. The identifying information may include the user's name and/or ID number, or any other suitable identifier. The first video stream 403 and second video stream 404 may be the video streams provided by the user device 1, and may be received directly from the user device 1 or from a video storage server 6. The administrator may be able to pause or enable the video for multiple sessions at once. The sound control 406 may allow an administrator to listen to the sounds from a particular session, automatically muting all other sessions. The additional information window 405 may include other information about the user and metadata collected, such as their address, phone number, contact list (i.e. viewers 9 who should be notified), biometric readings, if available, etc. A message window 407 may track all messages exchanged with a user. And may also include a live text feed of the audio stream generated by an AI model or text-to-speech program processing the audio stream.

A proprietary dispatcher interface allows two-way text communication, PIN-based event deactivation, and access to archived stream data. The emergency stream operates in picture-in-picture (PIP) mode, allowing users to multitask while remaining under monitoring. Artificial intelligence-based threat detection may autonomously initiate the emergency state when visual indicators of violence or weaponry are detected.

The backend architecture may include a Node.js server, MongoDB database, AWS S3 media storage, Firebase Cloud Messaging for push alerts, Agora SDK for video transport, and the Noonlight API for emergency responder dispatch. Recordings may be encrypted and retained for a minimum of ninety (90) days to support review or forensic use.

The emergency system may include the following elements:
1. Triggering Mechanisms: Activation via widget taps, shake gestures, safewords, button combinations, or external accessories.
2. Livestreaming: Dual-camera operation capturing user-facing and world-facing perspectives with environmental audio.
3. Geolocation Tracking: Periodic and continuous transmission of location coordinates.
4. Dispatcher Interface: Real-time access to streams, two-way messaging, emergency logging, and user PIN verification.
5. Artificial Intelligence Threat Detection: Mobile-embedded inference engines detect aggressive behavior, firearms, or blades.
6. Cloud Architecture: MongoDB for data, AWS S3 for media, Agora for streaming, and Firebase for messaging.
7. Security Layer: TLS 1.2+ encryption, secure token-based authentication, and user-controlled stream deactivation via PIN.
8. Fail-Safe Modes: SMS fallbacks, Wi-Fi triangulation, offline video caching, and reconnection syncing.

The system supports flexible configuration across subscription tiers (basic, enhanced, pro, enterprise) and accommodates different use cases including rideshare trips, campus security, eldercare, domestic violence intervention, and solo travel.

The advantages of systems using the disclosed concepts are as follows:
Enables discreet activation in high-risk scenarios through multiple input methods—voice, gesture, widgets, hardware buttons—ensuring user safety even when speech or overt movement may escalate danger.
Supports dual-camera, real-time visual/audio transmission from both front- and rear-facing lenses, providing dispatchers with a complete situational view for accurate decision-making.
Seamlessly integrates with third-party dispatch platforms such as Noonlight, leveraging pre-existing infrastructure for scalability, legal compliance, and resource coordination.
Delivers AI-based automated activation with on-device inference engines trained on visual indicators of violence, enabling passive protection when a user is incapacitated or unaware.
Offers background and Picture-in-Picture (PIP) streaming modes, allowing users to minimize or exit the app without interrupting the emergency broadcast, preserving both discretion and connectivity.
Sends high-priority sound alerts using native Critical Alerts frameworks that override device mute and Do Not Disturb settings, instantly notifying emergency contacts with location and video access links.
Ensures data continuity through robust fail-safes, including fallback to SMS-based location alerts, offline video caching, auto-resume streaming on reconnection, and Wi-Fi/cell-tower triangulation for location estimation.
Enables cloud-based evidence archiving via MongoDB and AWS S3, retaining timestamped video, audio, messaging, and location metadata for at least 90 days to support post-incident analysis or legal proceedings.
Supports diverse use cases: rideshare safety, university and campus security, eldercare monitoring, domestic violence response, and remote or solo travel safety—making it highly adaptable across industries.
Designed with accessibility and equity in mind, offering voice-guided onboarding, scalable UI for seniors or visually impaired users, and preset contact templates for simplified emergency configuration.
Provides modularity through tiered feature plans (e.g., Basic, Enhanced, Pro, Enterprise), allowing customized feature access based on user needs or institutional deployments.
Offers interoperability with wearables and smart accessories, enabling Bluetooth-based emergency activation via smartwatches, lanyards, or health-monitoring devices. through multiple input methods, including voice, motion, and hardware, reducing user burden in dangerous conditions.
Supports dual-camera, real-time visual/audio transmission, giving responders full environmental context and improving response accuracy.
Seamlessly integrates with emergency dispatch systems and third-party platforms such as Noonlight, expanding the system's reach and interoperability.
Offers AI-based automated activation with on-device inference for real-time threat detection, even when the user is unable to act.
Operates in background/Picture-in-Picture (PIP) mode, allowing the user to multitask or conceal their actions, increasing user safety in escalating scenarios.
Delivers high-priority, device-override alerts using OS-native Critical Alerts frameworks to notify emergency contacts instantly, even during silent or “Do Not Disturb” modes.
Includes robust fail-safes such as offline caching, fallback SMS, and reconnect logic to ensure continuity despite poor connectivity.
Facilitates post-event review through secure, encrypted cloud archival of all emergency session data, supporting legal, insurance, or investigative use cases.
Adapts to multiple use cases—rideshare, campus safety, domestic violence, eldercare—offering wide commercial and social impact.
Designed with accessibility in mind, offering UI flexibility for elderly or mobility impaired users, voice-guided interaction, and customizable onboarding.
Supports dual-camera, real-time visual/audio transmission
Integrates seamlessly with emergency dispatch systems
Offers AI-based automated activation with on-device inference
Operates in background/PIP mode, increasing stealth
Includes robust fail-safes for connectivity and user error
Facilitates post-event review through secure data archival

The present invention introduces a transformative system for real-time emergency response that integrates user discretion, intelligent automation, and seamless communication. By combining dual-camera live streaming, continuous location tracking, and real-time audio capture within a secure, cloud-enabled ecosystem, the invention empowers users to request and receive assistance without escalating danger or requiring active verbalization.

The incorporation of AI-based threat detection, critical alert delivery through operating system entitlements, and persistent Picture-in-Picture streaming ensures both active and passive scenarios are accounted for, safeguarding users even when they are unable to interact with their devices. Furthermore, the layered architecture-leveraging third-party dispatch APIs, mobile SDKs, encrypted databases, and offline fail-safes-makes the system scalable, reliable, and resilient.

Through flexible configuration options, accessible design for all user demographics, and applicability across diverse real-world environments including rideshare, campus safety, eldercare, and solo travel, the invention stands as a comprehensive personal security solution. It is technologically robust, commercially viable, and positioned to redefine modern mobile safety standards through patent-protected innovation, in emergency communication-discreet, autonomous, and context-rich. It is technically sophisticated yet user-accessible, enabling continuous monitoring and immediate response in life-threatening scenarios without requiring user verbalization or manual intervention.

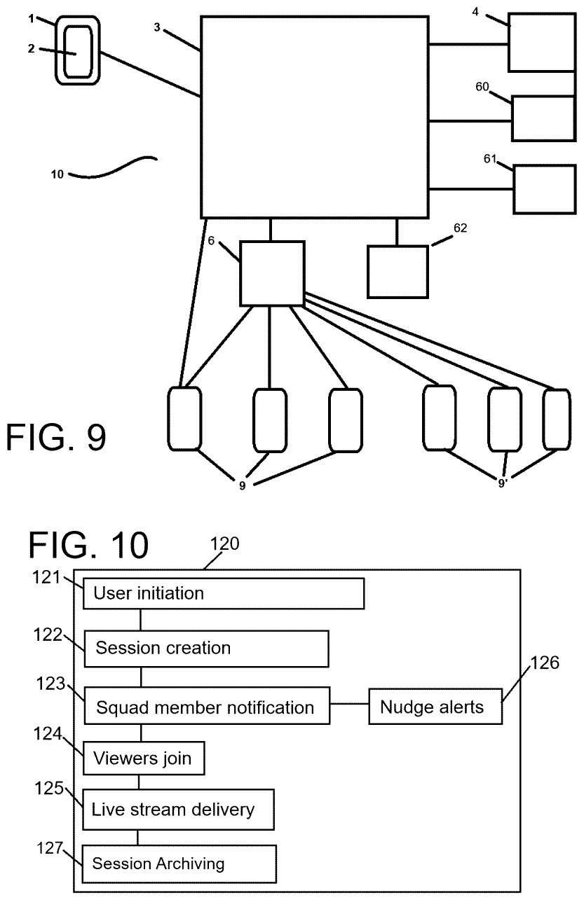

FIG. 9 illustrates a block diagram of the system 10 architecture, having user devices (1), client app (2), backend server (3), media storage (6), transcript service (60), AI summary engine (61), notification service (62), database (4) and end user devices 9, 9′ for “Squad A” and “Squad B”, respectively. The user device may be a computing device having more than one camera, a microphone, and a GPS receiver. The client application 2 may allow a user to set preferences, such as defining one or more Squads. A squad may include a set of members that are contacts of the user, such as friends or family. Squad members may me users of the client application 2, having it installed on their end user devices 9, 9′ such that they can receive notifications via same, or they may simply be people who have an end user device 9, 9′ that may receive notifications via SMS message, email, or other messaging application, and may be provided with a link to view the live broadcast. Squads may be defined in advance, and may be configured to receive notifications automatically when certain events occur, such as the user initiating a live broadcast, or a request for emergency response. For example, a user may define Squad A as friends that they are seeing that night, to be notified when a live broadcast is initiated, and may define Squad B as a parents, significant others, or other family, to be notified in the event they initiate a request for emergency response. The client application may also allow the user to configure additional preferences at the squad level, or individually for squad members, such as a time threshold when a notification times out and a nudge notification should be sent to the member/squad, notification channels (in-app, SMS, email, other applications) to be used for that member/squad, and other useful preferences known in the art or to be developed.

The client application 2 allow a user to initiate a live broadcast session, by providing a “GO LIVE” button or other similar functionality. Upon initiation of a live broadcast session, the client application may capture video from at least a first and second camera of the user device, audio from a microphone, and optionally, GPS data from the GPS receiver. For example, when the user device 1 is a dual camera phone having a front and rear facing cameras, the client application may simultaneously activate both the front and rear facing cameras and capture video from both. Upon initiation of live broadcast, the client application may automatically send push notifications to any pre-defined squads that are marked by the user to receive notifications upon initiation of a live broadcast. The client application 2 may also allow the user to define a new squad to be notified for this particular live broadcast. This may be achieved by allowing the user to select squad members before or after the user hits the “GO LIVE” button or otherwise initiates the live broadcast.

The client application 2 may allow a user to initiate a Trip Mode functionality, specific o live broadcast sessions that will involve traveling from one location to another. In such circumstances, the client application 2 may generate or be provided with a planned route and estimated time of arrival, either by calculating the planned route itself, or through the use of a mapping application, such as GOOGLE® Maps, APPLE® Maps, MapBox, WAZER or other mapping application. The client application may also stream and record an actual route as the aggregate of the GPS locations that it receives and streams. The client application may allow the user to initiate an emergency alert, as described above, to request an emergency response from local authorities. The planned route data and ETA may be updated during the trip, as necessary and notifications may be sent out to the extent that the actual route deviates from the planned route past a certain threshold, or to the extent that the ETA changes beyond a certain threshold. These occurrences may also be triggering events for certain squads set by the user to receive notifications about the live broadcast.

The backend server 3 may handle session creation, as described above, coordinating the creation of a broadcast session and controlling the distribution of the video feed to the squad members who are notified to view same. The back end server 3 may issue streaming credentials to the viewers to provide the distributed video only to those users. The back end server 3 ingest the media streams from the user, receiving and storing a copy of same, or may direct the media streams to a video storage service that can be used to distribute both the video streams and the archived video upon completion of the live broadcast. The backend server may receive the audio stream and may further provide same to a transcription service 60. The transcription service may receive and analyze the audio stream and may generate a live transcript of what is said on the audio stream using speech-to-text algorithms and programs. Alternatively, a transcription service may utilize an AI model that is trained to process audio streams and generate a text transcript for them. Similarly, the live broadcast may be provided to an AI model that is trained to process video, audio, GPS location data and/or time stamp data, and to generate a summary description of what takes place during the live broadcast. The AI may further be trained to identify important portions of the live broadcast and to generate a highlight real of such moments. The backend server 3 may also utilize a notification service 62 to generate and send notifications to the users as needed and as described herein. The notification service may initiate and transmit push, SMS, or in-app alerts for live broadcast initiation, nudge reminders, trip commencement, ETA updates (23), arrival (25), and emergency alerts (33). It also relays live location updates (34).

The data generated from this process may be processed and stored in a database 4. that may be separate from or integrated with the video storage 6. Indeed, persons of skill in the art will recognize that the backend server maybe integrated with the systems (the video storage 6, database 4, transcription service 60, AI summary service 61, and the notification service 62, or some or each of those may be a separate service/model that is communicated with through an API or other suitable communication protocol.

FIG. 10 illustrates a method for distributing a live broadcast session 120 in accordance with the disclosed concepts. The method 120 may include receiving a user initiation 121 of a live broadcast, creating a session 122 for the live broadcast, 123 notifying selected squad members, 124 processing when viewers join, 125 delivering the live stream, sending nudge alerts 126 for squad members who do not join the live broadcast, and session archiving 127. The backend server 3 may receiving the user initiation 121, which may include receiving message from the user's client application 2 that the user has hit the “GO LIVE” button or other suitable communication. This may include a list of squads or squad members to be notified based upon current user input or prior user preferences. Upon receiving such a notification, the backend server may create a session 122, which may include identifying a storage location for the users live broadcast datastreams, beginning recording of same (or coordinating with a video storage location 6 to begin storing same, generating credentials for the user to stream their live broadcast and for the squad members to be notified and view the live broadcast. This may include generation of a persistent link where both the live broadcast and the archived broadcast may be made available. This may further include initiating sessions with the transcription service 60, summarizing AI 61, and notification service 62 to effectuate various features of the live broadcast service as described above.

Once the session is created 122, the backend server may notify squad members 123 that the broadcast is being initiated. This may include initiating notifications to the squad members, in accordance with the initiating user's preferences and/or the receiving squad members' preferences as to how such notifications should be sent. Whenever a user squad member/viewer joins 124, the back end server 3 may record their joining, and may send confirmation to the user that the squad member has joined. Finally, the back end server 3 may check the credentials of joined viewers to ensure that they are authorized to receive the live broadcast. If the squad member/viewer has a client application on their device, the backend server may instruct the squad member's client app 2 to begin accessing or receiving the live broadcast data streams. If the squad member does not have the client application on their end user device 9, 9′, the backend server may provide the squad member with a link to where they may view the live broadcast. If a squad member does not join the live broadcast within a certain time threshold set either by the user or the squad member, the backend server may initiate a nudge notification 126 to remind the squad member that the live broadcast is underway. The user may also be provided with a graphical user interface button to manually send nudge notifications to any squad members that have not yet joined, individually, by squad, or by broadcast session (i.e. to all members of all selected squads who have not yet joined).

Session archiving 127 may include creating and storing a recording of the information streamed during the live broadcast session, and the summaries generated for same. This may include recordings of the first and second video streams, the environmental audio stream, the generated transcript of the environmental audio stream, an AI generated summary of the first and second video streams, and any time stamp data. This may further include storage of messaging during the live broadcast session, and records of which straw members joined the session, when they joined, and which were nudged. The archived session may further be recorded to the squads, or in other words, stored in a manner such that the squads that were invited to participate in the live broadcast session are provided with access to the archived session, while other users are not. This may be accomplished though storing the archived session at a storage location that controls access to the stored data, such that the squad members must log in, or otherwise present credentials in order to access the archived session data. If the squad members are accessing the archived session data from within the client application on their end user device 9, 9′, the access may be managed between the client application and the backend server/video storage service such that it requires no further action from the user or squad member.

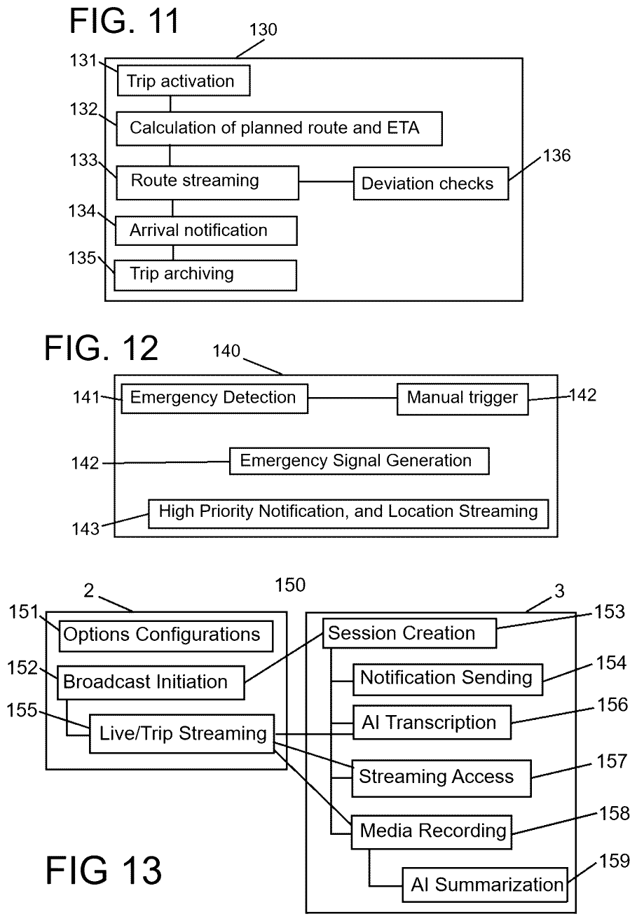

FIG. 11 illustrates a flow diagram for a for initiating a trip mode broadcast 130 in accordance with the disclosed concepts. The method for a trip mode broadcast 130 may include trip mode activation 131, calculation of a planned route and/or eta 132, route streaming 133, arrival notification, 134, trip archiving 135, and deviation checks 136. The user of the client app 2 may initiate a trip mode broadcast by hitting a “TRIP MODE” button, by selecting a “TRIP” or similar option when initiating a live broadcast, or by default, whenever a live broadcast is initiated, unless the user deselects “TRIPMODE” or indicates that it is non-trip broadcast. Trip mode may be enabled at the start of the broadcast, or maybe enabled during the broadcast. The user may further provide a destination location as part of activating trip mode. When the backend server 3 receives a trip mode activation 131, it may create a session 122 as described above, with additional features or functionality enabled to display the user's location together with the live broadcast. This may involve communicating with and establishing credentials with a map service. Upon trip mode activation 131 the backend server may compute a planned route and estimated time of arrival (ETA) 132, or may communicate with a mapping service to obtain a planned route and ETA. Alternatively, the trip mode activation request may provide same, particularly in implementations where the client application is integrated with a ride share mapping application. The backend server may then notify squad members of the trip mode broadcast as above 123, and begin route streaming, which may include tracking the GPS locations provided by the user, and displaying those locations overlayed on a map at the same time as the data streams are being presented. Accordingly, during transit, the user's client app 2 streams the route 133 together with the dual-camera video and audio streams, updating server as to their progress in the trip. Upon arrival, the client may issues an Arrival notification 134 and ends session. The backend server may then archive the trip mode session, or initiate archiving of same using the appropriate services. The archival of the trip mode broadcast may include storing the video, audio, route data, audio transcript, and AI video summary, as discussed above. It may further include time stamp data, and align all data streams to be presented chronologically. Either or both of the client application 2 and backend server may initiate deviation checks periodically or if the planned route or ETA are changed beyond a threshold that may be set by the user or may have default settings. This may prompt the user with a status check to ensure that they are ok, or it may prompt an administrator to review the data stream for potential signs of trouble.

FIG. 12 illustrates a flow diagram for a method for initiating an emergency alert 140 in accordance with the disclosed concepts. Method 140 may include emergency detection 141 manual trigger 142, emergency signal generation 143; and issuing a high-priority squad alert 144 with live location link to all selected Squads until cancellation. Emergency detection 141 may occur on the client app 2, on the back end server 3, on separate specialized AI trained to detect emergency from video and audio feeds, as discussed above, where the system, whether by using an AI as described above, or a software system encoded to process video and audio streams to detect an emergency detects danger sufficient to trigger an emergency response signal. Similarly, manual trigger 142 may include the user triggering a request for emergency services, an administrator viewing the broadcast and initiating such a response, or a squad member watching the broadcast triggering an emergency signal. In the latter cases the user may be provided with a notification that someone has initiated an emergency response request, and may be provided with an opportunity to cancel same. When such a request is made, the back end server may handle it as described above, and route the request to an emergency dispatcher 75 with the local authorities or to an emergency services provider 7 which handles such requests.

FIG. 13 illustrates a flow diagram for a system 150 for live broadcasting and archival in accordance with the disclosed concepts. The system may include a client app 2 and a backend server 3. The client app may allow a user to configure options 151, initiate a broadcast 152, and engage in live streaming or trip streaming. The backend server 33 may facilitate same by creating a broadcast session 153, sending notifications 154 to the appropriate squads, engaging AI transcription 156 (or other transcription services), providing the appropriate users with access to the live streaming or trip streaming 157, ensuring that the broadcast media is recorded 158, and providing the recording to a AI trained to analyze and summarize the broadcast 159. The client app 2, may allow the user to set configuration options, as discussed in greater detail above, including creating squads, setting preferences for how and when those squads should receive notification of the broadcast, which may include whether they are provided with the livestream or with a time-delayed copy of same (for example, some users may be provided with live access while others may be delayed by a set amount of time (10 seconds, 1 minute, 1 hour, etc.) depending on the type of stream and the reasons for the delay (user safety, providing premium members with early access, etc.). The client app 2 also allows the user to initiate a live stream or a trip stream 152, which may include streaming with one or more cameras simultaneously, streaming environmental audio, streaming a prerecorded soundtrack or background sounds/music, streaming location information, including time stamps, and any other information which a user may wish to convey. Once the client app 2 receives confirmation that the session 153 has been created from the backend server, the client app 2 may then stream the selected data streams for the live stream or trip stream 155.

The backend server may create a session 153, as described above in greater detail. Once the session is created 153 it may communicate the success of creation to the client app 2, and may begin sending notifications 154 to the appropriate squads. The backend server 3 may provide the live/trip stream audio stream to a transcription service, such as an AI transcription service 156 for live transcription of words detected in the audio stream. The backend server may also manage streaming access, providing notifications and appropriate access to end users in accordance with the streaming user's preferences and settings. Once the live/trip stream has ended, the backend server 3 may store, or coordinate the storage of, a recording of the live/trip stream 159. The recording may be provided to an AI trained to summarize the broadcast data, or the AI may be provided with access to the streams to begin generating the summary during the live/trip stream. Each of the backend server's 3 tasks may be done directly by the backend server 3 or through communication with services, such as a notification service 62, a transcription service 60, a video storage 6 and database 4, and an AI summarization service 61.

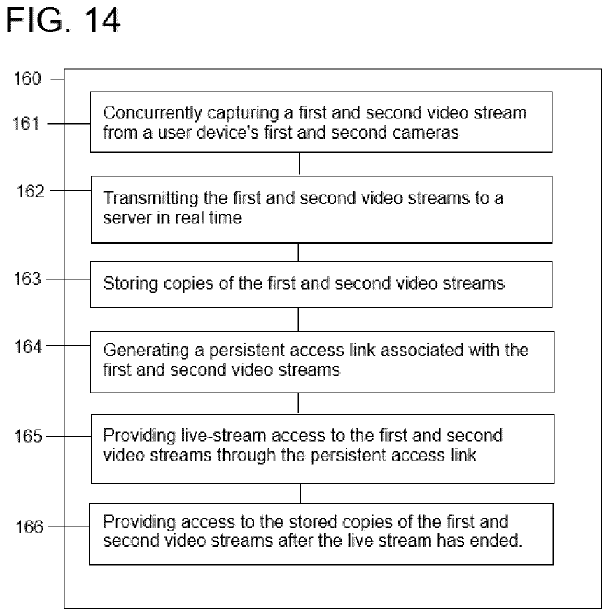

FIG. 14 illustrates a flow diagram for a method for continuous video recording and live broadcasting 160. The method may include concurrently capturing a first video stream concurrently from a first camera of a user mobile device, and a second video stream from a second camera of they user mobile device 161, transmitting the first and second video streams in real time to a server 162; storing copies of the first and second video streams 163; generating a persistent access link associated with the first video stream and the second video streams 164; providing live-stream access to first and second video streams through the access link 165; and providing to the stored first and second video streams using the same access link after the live-stream has ended 166.

Capturing a first video stream concurrently from a first camera of a user mobile device, and a second video stream from a second camera of they user mobile device 161 may include providing an application that runs on a user mobile device, such as a smart phone, that has at least two cameras, such as a forward-facing camera and a rear-facing camera. The application may be configured to activate both cameras at the same time and to encode a video stream the video stream may be encoded with any suitable algorithm known in the art or to be developed, including but not limited to H.264, H.265, or VP9. Similarly, transmitting the first and second video streams in real time to a server 162 may be implemented by the same application establishing a connection to the server through any suitable protocol known in the art or to be developed, to send both video streams as they are being recorded in packets, or in any other suitable manner. Storing copies of the first and second video streams 163 may be accomplished server side, or may be performed on the user device for later transmission of the full video to the server. Regardless of whether the storing is done server side or mobile device side, the stored copies may be further processed and encoded to desired levels of compression and quality. Similarly, generating a persistent access link associated with the first and second video streams may be performed server side, or may be coordinated from the user mobile device application to create a persistent url, or other suitable link, where the live stream of the first and second video streams may be accessed, and where the same url or link may be used after the live stream has ended.

Once the persistent access link has been created, the server may provide live stream access through the first and second video streams through the persistent access link 165 while the streams are being recorded. This first and second video streams may be presented in split screen fashion, side by side for vertical video layouts, or one above the other for horizontal video layouts. Alternatively, the two video streams may be presented in picture-in-picture format, and the viewer may be provided with a user interface the persistent access link by which he can change the focus of the picture-in-picture display from one stream to another. The user interface may also allow a user to switch between a split-screen view, to a picture in picture view, to a single-camera/stream view, or any combination thereof. For embodiments with augmented reality the interface may allow the viewer to toggle such features or information on and off. Additionally, in embodiments with metadata, such as time stamps and/or location information, those may be displayed together with the video streams, either within the video streams or adjacent to the video streams, and the user interface may allow a user to toggle what information is displayed and how it is displayed. For example time stamps may be displayed with a text overlay over one or both videos, or above, below or adjacent to one or both videos, or not at all. A map showing location information may similarly be displayed adjacent to, or as a picture-in-picture in a selected location of one or both videos. The same persistent access link may be used to provide access to the stored copies of the first and second video streams after the live stream has ended 166. The same viewing an meta data options may be presented to a viewer with respect to the stored copies of the completed video streams.

### System Components:

Mobile Device: Equipped with camera(s) capable of simultaneous dual-camera video recording or just a one way camera.
Custom System/Server (3rd-i Server): Configured to receive, store, and manage live and recorded video streams.
Access Interface: A web-based or app-based platform that allows users to access live and archived broadcasts via a unique, persistent link.

### Operational Methodology:

Video Capture: The mobile device captures video and simultaneously uploads the footage to the server in real-time.
Broadcasting: Users can broadcast live video streams which are accessible through a custom or predefined URL.
Persistent Access Link: A unique URL is generated for each video session, which remains valid for accessing both the live broadcast and the archived video post broadcast.
Dual Camera Functionality: During the broadcast, the host can activate a dual camera mode, displaying two simultaneous video feeds in a split-screen format on the viewer's interface.
Post-Broadcast Access: After the live session ends, the video is stored on the server and remains accessible through the same URL used for the live broadcast.
Additional Features: Video summary generation and audio breakdown are optional features that can be integrated to enhance content accessibility and analysis.

### Use Cases:

Live Event Coverage: Users can live stream events, and viewers can access the broadcast in real-time or revisit the archived video through the same link. The dual camera ability adds to the experience.
Sharing Long Videos: Using the shareable link, a recorded broadcast lasting up to hours can be accessed within seconds. If the user streamed with a dual camera setup, the recipient or viewer of the video will also be able to experience it in dual camera mode.
Project Management & Client Collaboration: Professionals can share a live or recorded stream of meetings, walkthroughs, or on-site inspections with clients or team members via a persistent link. The dual camera feature allows simultaneous viewing of the presenter and the subject matter (e.g., product demos, design layouts, construction progress). Integrated messaging during the stream fosters real-time feedback and collaboration, enhancing remote engagement and project transparency.
Real Estate Tours: Realtors can livestream property walkthroughs to clients who cannot attend in person. With the dual camera mode, clients can see both the realtor and the property simultaneously, allowing for a more personalized and interactive experience. This real-time communication ensures buyers receive context and explanations as they view the home, improving decision-making from a distance.
Field Reporting and Journalism: Reporters can livestream news from the field while showing both themselves and what's happening around them. Viewers get context from the reporter and visuals from the scene, all accessible via a single link for both live and replay.
Customer Support & Troubleshooting: Tech support teams can guide customers through setup or problem-solving via livestream. One camera shows the customer or technician, and the other shows the product or issue, allowing for clearer support and remote assistance.
Fitness and Wellness Coaching: Personal trainers or wellness coaches can run live sessions where one camera captures their face (for communication) and the other captures the exercise or technique being demonstrated. Clients can watch live or later via the same link.
Security Monitoring and Check-ins: Individuals or businesses can stream security footage to remote viewers. For example, a delivery driver or security officer can use dual cameras to show both their face and their surroundings while patrolling or entering a location.
Content Creation & Influencer Marketing: Content creators can stream behind-the-scenes footage while simultaneously addressing their audience. This enhances authenticity and engagement. The persistent link makes it easy to reshare or archive the content.
Legal or Insurance Documentation: Dual camera livestreams can be used for remote walkthroughs of damage (e.g., property, vehicle) while narrating or showing identification. The persistent link ensures easy sharing with claims adjusters, lawyers, or insurers.
Virtual Tours and Museum Guides: Museums, galleries, or travel companies can offer livestreamed guided tours with a docent visible on one camera and the exhibits on the other. Viewers can join remotely and revisit the experience afterward using the same link.
Remote Learning & Student Projects: Students can present projects, science experiments, or performances remotely using dual camera mode-showing themselves presenting and their work simultaneously. Teachers and peers can watch live or later via the link.
Remote Interviews and Hiring: Companies can use the system to conduct and share interviews where the candidate and the interviewer are both visible in dual camera mode, with the session saved and shareable via a single link for other stakeholders to review.
Educational Workshops: Instructors can utilize the dual camera functionality to provide multiple perspectives during live tutorials.
Personal Broadcasting: Allows individuals to share moments with friends and family, who can join live or watch later using the shared link.
Doctor's Appointment Broadcasting: This feature enables individuals to share their medical consultations with friends and family. Loved ones can join the appointment live or view it later through a shared link. This accessibility helps those who cannot be present understand the details of the medical visit, ensuring they are informed and can provide support regardless of their physical location.
Driving Broadcast or (drivestream): This feature enables individuals to share their driving experiences with friends and family. Loved ones can join live or view recordings via a shared link. The dual camera allows friends and family to view both camera angles, the driver and the road ahead. This functionality is perfect for those who want to keep an eye on drivers to ensure their safety throughout their journey.

The present invention thus provides a method and apparatus for real-time video uploading and broadcasting comprising: capturing video using a mobile device; simultaneously uploading the video to a server; generating a persistent access link for said video; enabling live access and post-broadcast access via the same link. The video capturing method and apparatus may further include dual camera functionality, providing a split-screen view on the user interface.

The present invention significantly improves the user experience in video broadcasting by simplifying the process of accessing live and archived content through a single, unchanging link, while offering advanced features such as dual-camera functionality and video analytics.

Through flexible configuration options, accessible design for all user demographics, and applicability across diverse real-world environments including any circumstances in which a user may wish to broadcast information, and particularly in situations where the broadcast encompasses a trip and where safety is a concern.

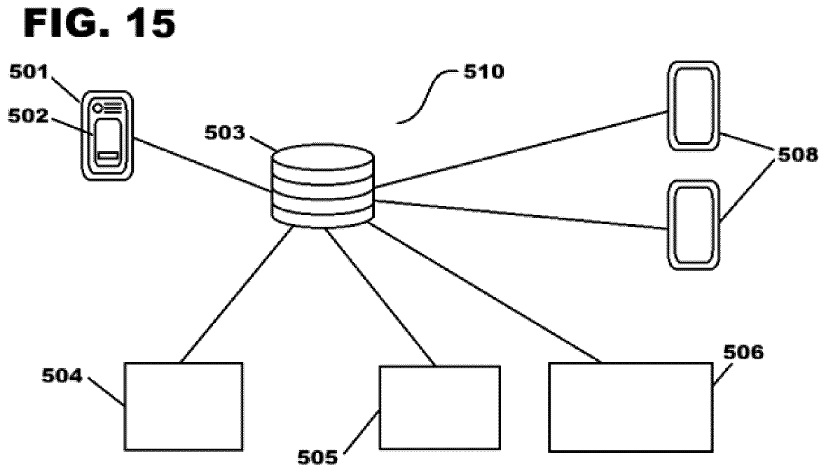

FIG. 15 illustrates, a system 510 diagram of a representative system architecture for triggering an emergency on behalf of another. The system 510 may include including client device(s) 501, an authorization/consent service 503, contact devices 508, an anomaly/context engine 504, a dispatch orchestration service 505, and a communication gateway 506. The client devices may be any suitable personal computing device, such as a smartphone, tablet, laptop, personal computers, smart watch, other personal computing devices, or other devices known or to be developed that can provide location information for the client user. The client device may 501 be provided with a client application 502, access and track location information, such as GPS data, such that it can provide location information for the user of the client device. Where GPS data is unavailable, the client application may use other data sources, such as communication with cellular phone towers, routers or gateways to estimate or calculate the location of the user.

The client application 502 may also provide an interface for the client user to set permissions, authorizations and preferences. For example, a client user may use the client application to define a list of close contacts, such as family and close friends, that are always authorized to initiate an emergency on their behalf. The client application may also provide the user with the ability to set a temporary authorization group, such as friends with whom the client user may be expecting to see, or traveling with or meeting somewhere on a particular day or night, to grant them temporary authorization to initiate an emergency on their behalf. The client application may further allow the user to place constraints on when and how a contact may be authorized to initiate an emergency response on their behalf.

Similarly, the contact devices 508 may be smartphones, smart pads, laptop computers, personal computers, smart watches or other personal computing devices owned or operated by the authorized contacts selected by the client user. Those may also have a client application 502 installed on them to allow them to view a client user's information and to initiate an emergency response on behalf of that user. Alternatively, the contact devices 508 may access a website where they may log in or otherwise provide authentication credentials, in order to initiate an emergency services request on behalf of the client user.

The authorization/consent service 503 may be a supervised or automated system or server that communicates with the client device to maintain a current list of individuals or groups that are authorized to initiate an emergency on behalf of the client user. The authorization/consent service may maintain a list of consent records for each client user, where a consent record may include The client's subject id, a contact id, the scope of authority granted (such as whether the contact can make on behalf requests for emergency dispatches), constraints (such as time windows, geofences, and risk thresholds which allow that contact to make such requests), a notification policy (such as whether the contact gets immediate, silent, or delayed notifications), revocation status, and a record of the date and time the consent was created, updated or revoked.

When a contact device 508 initiates an emergency request on behalf of a client user, whether through a client application 502 request or through a website request, the authorization/consent service 503 may verify that the contact has been and is authorized to initiate emergency services requests by and on behalf of the client user. The authorization/consent service 3 may serve as a control center for managing all communications with the various components of the system, and facilitating transitions to effectuate authorized requests for emergency services by a contact on behalf of a client user. Alternatively, a separate control server (not shown) may manage and control the communications between the various system components, and the authorization/consent service 503 may merely accomplish the function of verifying authorization and allowing a user to manage consent settings. Persons of skill in the art will recognize that various system components may be implemented independently or as parts of a single server or application in accordance with the disclosed concepts based on the needs of any particular implementation.

The anomaly/context engine 504 may analyze and track user location data provided by the client application 502 of the client user device 501. The client user may provide authorization for the client application to always be collecting their location information and to provide it to the anomaly/context engine 504. The anomaly/context engine may contain an artificial intelligence model trained to analyze user location data to identify standard or expected conditions, and anomalies or unexpected conditions. When an anomaly is detected the anomaly/context engine may ping the client user. The client user may further preemptively provide information to the anomaly/context engine 504 via the client application 502 to assist in this calculation. For example, a client user may put in a travel destination into their client application such that an expected route or travel path may be calculated. If the actual route or travel path taken deviates too far from the expected route, or if the actual route simply goes in the wrong direction, the anomaly/context engine 504. A variety of algorithms and techniques may be used to detect an anomaly including but not limited to geofence breaches, route deviation, dwell-time anomalies, device inactivity, abnormal hour/activity. The anomaly/context engine may generate a risk score using the foregoing. If the risk score is above a certain threshold, the anomaly/context engine 4 may initiate an attempt to contact the client user. If no response is received from the client user or if the risk score is above a second threshold, the anomaly/context engine 504 may attempt to contact both the client user and identified emergency contacts to notify them of the detected anomaly and/or lack of response from the client user.

The dispatch orchestration service 505 may be a system or service that interfaces with emergency dispatch, and which may provide specialized communication services, such as a group chat service allowing emergency services to communicate with the initiating contact, the client user, and any other users or persons that may be added to the group chat to facilitate the flow of needed information to emergency dispatch. To that end, the dispatch orchestration service 505 may integrate its systems to work with dispatch systems, or may provide services, such as th group communications service to emergency dispatch. To that end, the dispatch orchestration service may connect the contact user and/or client user to emergency services directly, by acting as a communication gateway 506, or it may facilitate the creation of a group communication with dispatch endpoint (public PSAP integrator or private GSOC/campus security).

The communication gateway 6 may provide access to a group communication channel to the initiating contact, the client user, and emergency users. It may further allow the addition of more users, such as other users affected by the same emergency, other users that may provide additional information to emergency dispatch regarding the client user's needs or health, or who otherwise should be notified of the status of the emergency dispatch, such as family. The communication gateway 506 may instantiate and broker a multi-party text communication session using one or more communication protocols, including but not limited to SMS, MMS, RCS, in-app chat, SIP, webchat, and/or voice to text communications from a client device or contact device. In some cases, the first responders may also be added to the group communication. The communication gateway may initiate a group communication with a public safety answering point (PSAP) or private dispatch endpoint utilizing a specialized interface to communicate with them, a web interface a API-based communication interface, or any other method or communication interface known in the art or to be developed enabling such communications with emergency dispatch services. The system and its various components may be provided with audit/privacy controls, including encryption, secure messaging, access scopes/TTL, revocation, data minimization, retention, and export for evidentiary use.

FIG. 15 illustrates a flowchart for a method for initiating an emergency request on-behalf of a client user 600. The method may include receiving a request to trigger an emergency dispatch 601, a verifying the authority of the contact triggering such a request 602, acquiring the location and identification of the client user for whom the emergency is being requested 603; resolving location information into a civic address that can be provided to emergency dispatch 604; initiating a request to emergency dispatch 605; initiating a group communication 606, optionally including additional subjects 607, and updating the location and timeline live 608, and closing out a completed call 609. A triggering event may be created by a contact who is communicating with the client user and is told they need emergency services, or by a client user who is unable to communicate with a client user and the client user is at a risk threshold sufficient for the contact to initiate an emergency request on behalf of the client user. For example, if the client user has not used their client device for a specific threshold amount of time leading to risk escalation. Alternatively, the system may prompt one or more of the clients' contacts, when an anomaly is detected or when the client has been out of contact for a threshold period.

Upon the initiation of a triggering event where one contact initiates an emergency services request on behalf of a client user, The receipt of that triggering event 601 may initiate a verification of authority 602 at the authorization/consent service 503. The verification of authority 602 may require that the contact provide multi-factor identification and/or solve a CAPTCHA or other human user verification feature. The authorization/consent service 503 and/or control center may, upon verifying that the requesting contact has authority from the client user to initiate emergency requests, acquire location and identification information about the contact user 603. This may involve querying the users contact devices and/or other login information that may be linked with his client user account to ascertain his or her identity and location. This may further involve accessing a client user's emergency card which may have important information needed by medical first responders, such as blood type, allergies, medical conditions, etc. It is worth noting that a contact may not know or have all the client user's information to initiate this request. Accordingly, they may provide some identity or location information on behalf of the client user, but the system may communicate with the client user's device and/or check recorded account information for additional verification or alternate location information. Once location information has been acquired, the system 510 may resolve that into a civic address 604 that can be used by emergency dispatch to direct emergency services. This may include translating GPS coordinates or other location information into a physical address, estimating a floor or unit number for a location, or it may include finding the nearest physical address and providing additional location information relative to the physical address provided. For example, for an emergency on a hiking trail, the location information may provide the address for the start point of the trail, and further information on the distance and direction that the client user may be from the start point. A confidence score or location radius may be provided to assist first responders in finding the client user.

The identity and location information, and contact identification, and or default information provided by the user for emergency services (such as allergies, medical conditions, etc.), as well as any other logistical information provided by the initiating contact, may be organized into a dispatch payload which may be transmitted to emergency dispatch at the initiation of an emergency dispatch request 605. The dispatch payload may include a subject identity, information for first responders. For example, a dispatch payload may include: a subject identity (name, address and/or phone number), ID number, government ID number, photograph, dispatchable address, more detailed coordinates, a location confidence score, a timestamp for last known location, a request type (such as an indication that it is an on-behalf request), the initiating contact's identity and/or ID, a reason code or reason for the request, and structured medical information (conditions, allergies, meds), and dispatch and/or initiating contact notes). The system may then create a group communication instance 606 including the initiating contact, emergency dispatch, and the client user, if available. Once the communication instance has been created, the contact, client user or emergency dispatch may optionally add additional subjects to the group communication 607 in order to facilitate providing emergency services to the client user. For example the contact may add additional subjects that may be with the client user that may require emergency services, the contact or client user may add parents or other persons having information that might be helpful to first responders, such as medical information like allergies or medical conditions, or emergency dispatch may add the first responders so that they can ask questions and obtain information as needed. Alternatively, the system may be set up to automatically add the first responders as they are assigned to a call. Anyone added to the group communication may be provided with the opportunity to provide attachments to the group chat in order to provide information to dispatch and/or the first responders. To the extent that the client user is not already included in the group communication, they may be added here, and it may be done through a safety aware notification policy (i.e. through a silent, disguised, or delayed notification) which may be governed by risk assessment. Disguised notifications may be disguised to appear to be a game or social media site such that a bad actor may not recognize it as a group communication with emergency dispatch.

As time progresses, the system may provide live updates and/or a timeline 608, as necessary, for example, if the client user is moving, updated location information and a timeline showing their movements may be included, if anyone on-site is rendering first aid, there may be a record kept of what first aid is being administered, and what results have been observed, etc. Emergency dispatch may also update the timeline with events such as “units dispatched”, “ETA to arrival” or “help arrived” or the like. The live updates and timeline stream may preferably be kept in a tamper evident log, including encryption or generating periodic hash codes or other security measures designed to show where data has been altered.

Once the first responders arrive at the scene and take the situation under control, or the emergency need is resolved and the request is cancelled the system may proceed to closure 109. At closure a communications session data record may be created. The communication session data record may include a session_id, participant IDs (including the dispatch endpoint, contact, whether the client user was present, and any optional additional subjects), transport, seeded fields from the client user's default data, an attachment manifest for any information provided by the client or contact, and live location feed or timeline. At closure, the group communication session may be archived as a whole or just the transcript per retention options, and the client user may review and alter or revoke consent controls based on same.

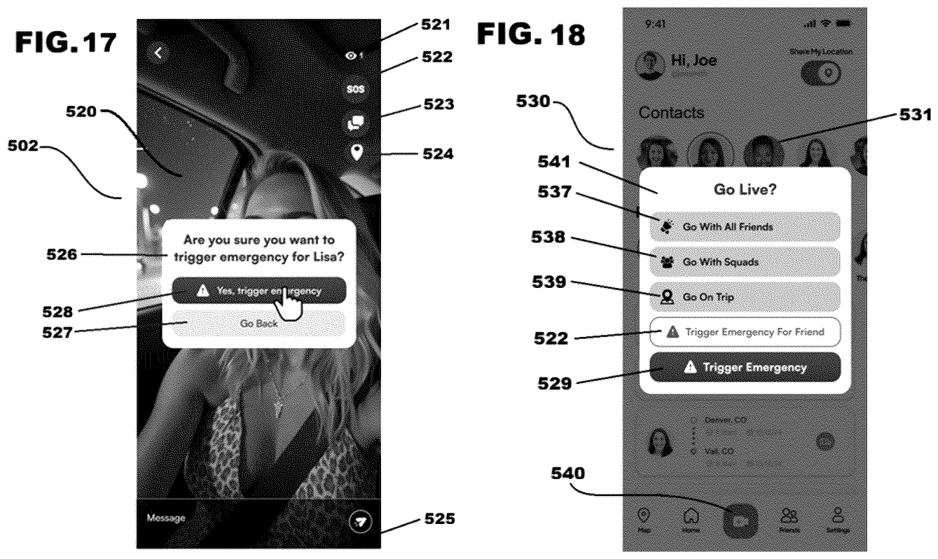

FIG. 17 illustrates a client application streaming screen allowing a contact to trigger an emergency response on behalf of a client user in accordance with the disclosed concepts. The user interface for the client application 502 may include a client user stream 520, a viewer count 521, an emergency response trigger button 522, a chat button 523, a map button 524, a text message section 525, an emergency trigger popup 526, an emergency confirmation button 527 and an emergency cancellation button 528. A contact viewing a client user stream 520 that sees the need for emergency services arise while they are watching the stream 20 may initiate an emergency response on behalf of the client user (i.e. the person streaming), beginning the method described above. For example, a contact using the client application 502 to communicate with the client user, may receive a client user stream 520, which may include video, audio and/or location streams. The viewer count 21 may indicate how many people are receiving and currently viewing the client user stream 520. The emergency response trigger button may be labeled with “SOS” or “911”, a cross, staff of Hermes or other suitable indicator for emergency services, and when pressed, may bring up an emergency confirmation popup 526 where a user can then press the emergency confirmation button 528 to trigger a request for emergency response and begin the method described above. Alternatively, if the emergency response trigger button 522 was pressed accidentally, the user may use the emergency response cancellation button 527 to close the emergency response confirmation popup 526. Chat button 523 may swap between a stream view, as shown, and a text-only chat room for viewers of the client user stream 20 and/or for text communications with the client user, or alternatively may overlay the text of such a chat on top of the client user stream 520. Map button 524 may toggle a mini-map overlay showing the location of the client user, or may swap th client user stream 520 from showing the video stream to showing a map with the client user's location stream. Persons of skill in the art will recognize that while the disclosed concepts may be implemented in client application as shown in FIG. 17, other implementation using or modifying existing technologies known in the art or to be developed may also be used within the scope of this disclosure. For example, the disclosed concepts can also be implemented as an add-on or extension for existing communications platforms, such as Face-Time, WhatsApp, Telegram, Twitch, Zoom, and other streaming technologies, and the like.

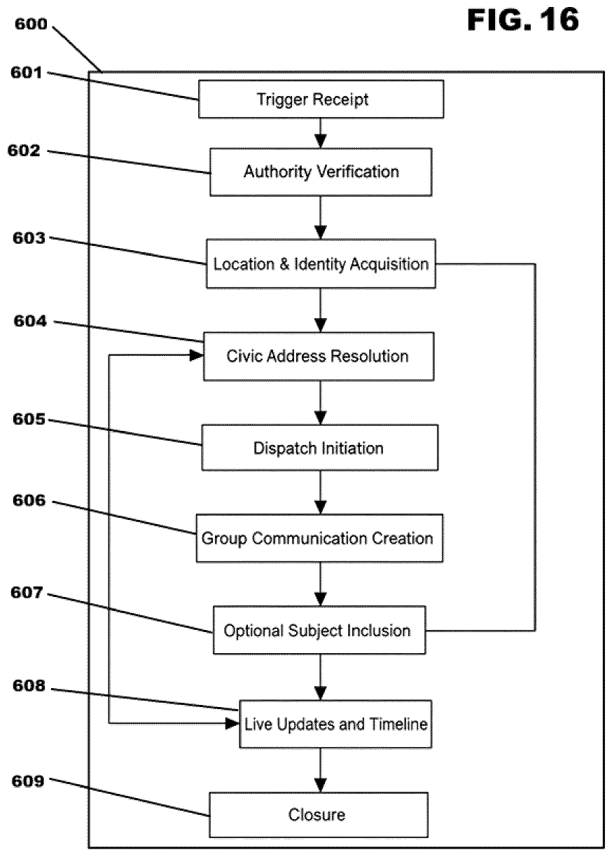

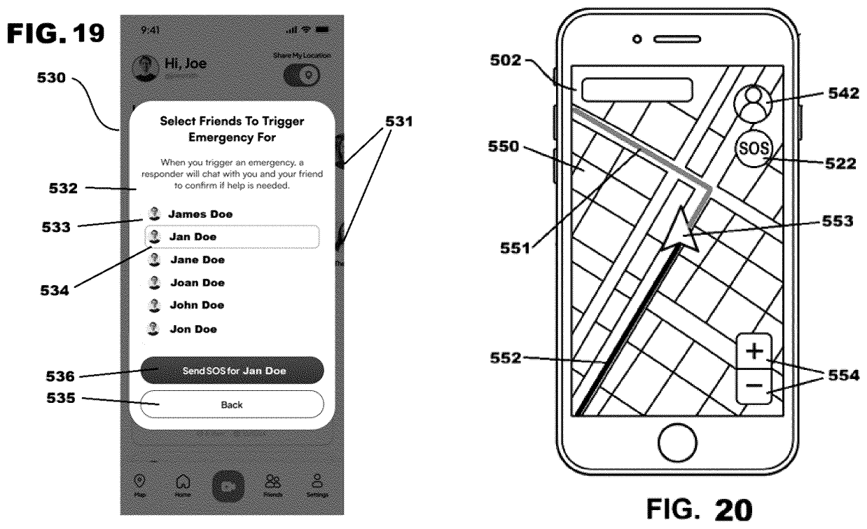

FIG. 18 illustrates an exemplary safety client application 502, showing a contact screen 30 that may include a listing of contacts 531, and an action button 540. A contact user pressing the action button 540 may open an actions popup 541 that provides a set of options the contact user may take. These may include a stream to all friends button 537, a stream to selected friends button 538, initiating a trip stream 539, an emergency for a friend button 522 and a self-emergency button 539. The stream to all friends button 537 or stream to selected friends button 538 may allow a client user to initiate a client user stream 520, as shown in FIG. 16 that can be viewed by their contacts as discussed above. The group of contacts for the selected friends button 538 may be preselected from the listing of contacts, or may be selected in an subsequent popup or screen before or during the client user's live stream. The trip stream button 539 may include location information in the client user stream 520 sent out to contact users, and may allow a client user to set a starting location, a destination, and an expected route, that may be provided to contact users as part of the client user stream 520, and is information that the contact users can use to determine whether there is an emergency (for example if the actual route deviates from the expected route by too much), or that can be provided to emergency dispatch if an emergency response is triggered. The trigger emergency for a friend button 522 may allow a contact user to initiate a request for emergency services on behalf of a client user immediately or via a emergency confirmation popup, as shown in FIG. 19 and discussed below. The trigger emergency button 529 may trigger a request for emergency services for the client user directly.

FIG. 19 illustrates a client application 502 contacts screen 530 allowing a contact to trigger an emergency response on behalf of a client user in accordance with the disclosed concepts. The contacts screen 530 may include a listing of contacts 531, which may be organized by first name, last name, grouped into categories or “squads”-specific groups of contacts or friends. A contact user who receives a message indicating than an emergency response is necessary from a client user outside of the client application (such as a text message or telephone call, or watching an emergency occur on an out-of-client-application stream), and recognizes the need for emergency services may initiate an emergency response on behalf of one or more client user (i.e. the person(s) needing emergency services), beginning the method described above, by opening their client application 502 to their contacts screen 530. They may then trigger an emergency response request as discussed above with respect to FIG. 18, or by selecting a contact or contact group and pressing an emergency services trigger button 522 on the contacts screen 530 (not shown), or by providing another input triggering the request (such as holding down a part of the screen for a threshold amount of time, or double- or triple-tapping device buttons or graphical interface buttons, receiving a signal from a third party device, such as a panic button or any other suitable input known in the art or to be developed. The client application 502 upon receiving such input may then display an emergency response confirmation popup over the contacts screen 530. The emergency response confirmation popup may include a listing of contacts 533, which may be a single contact or a selected set of contacts, such as a contact group or squad, or all contacts, if none were selected prior to providing the initiating input. The contact user may be able to toggle the users listed in the listing of contacts 533 into a selected state 534 to indicate that the emergency response request applies to them. In this manner, the contact user may then confirm, modify or select the client user or group of users on whose behalf they wish to trigger an emergency response request from the listing of contacts 533. The contact user may further cancel the emergency response request using a cancellation button 535, or confirm and trigger a request for emergency response by hitting a confirmation button 536. The confirmation button 536 may display a text summary of client users on whose behalf the emergency request is being submitted as additional verification. Once the contact user presses the confirmation button, the triggered request may be sent to the authorization verification service, beginning the methods described above.

FIG. 20 illustrates a streaming map-view screen 550 of a application 502 allowing a contact to trigger an emergency response on behalf of a client user in accordance with the disclosed concepts. The streaming map view screen 550 may be available to a contact user while a client user is streaming, such as when the client user initiates a trip stream, and puts their desired destination and expected route 551. Alternatively clients users who share their location with the contact user may allow their contacts to always have access to their current location, such that at any time a contact user, so authorized, can open the map view screen for this contact user and see their current location. The streaming map view screen may include a streaming view swap button 542, allowing the user to change to a streaming view where a video stream can be viewed, such as the example shown in FIG. 502. The streaming map-view screen may further have an emergency trigger button 522 allowing a contact user to trigger a request for emergency services on behalf of the contact user. As with the streaming screen 520, the map-view screen may come with a chat button 523, a messaging area 525, and may overlay a chat room over the screen or swap to a chat room view to facilitate text communication. When a contact triggers a request for emergency services by hitting the emergency trigger button, a confirmation popup 526 may be shown before to get confirmation via a confirmation button 528 before the request is acted upon. Once the confirmation button is hit, a method as described above may be initiated when the emergency trigger sent by the contact user is received and processed.

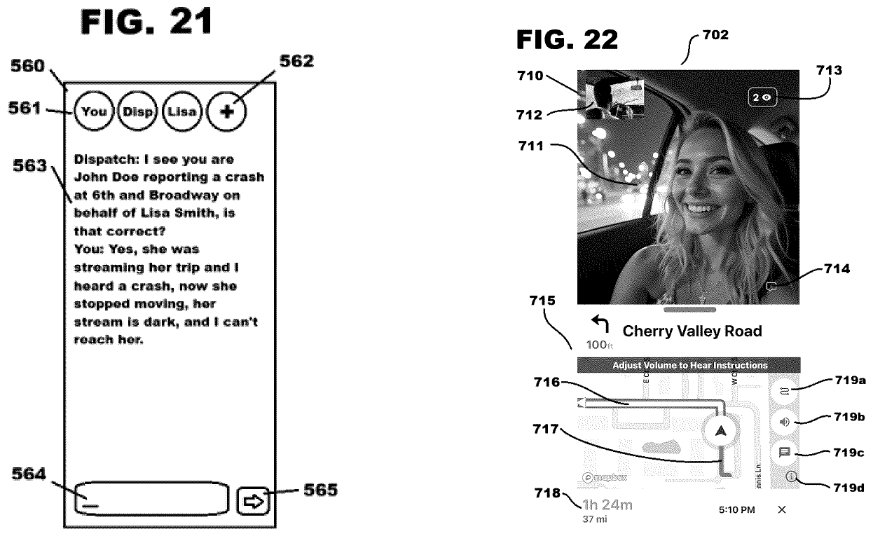

FIG. 21 illustrates an exemplary group communication screen 560 in accordance with the disclosed concepts. The group communication screen 560 may be opened as the result of an initiating a group communication 606 after contact triggers a request for emergency services on behalf of a client user. The group communication screen may include a participant list 561, a “add” button 562, a communication log 563, a texting area 564, and a send button 565, and participant buttons 566. The participant list 561 may include participant buttons 566 for the participants—as shown, dispatch, the contact user “John” that initiated the emergency request, the client user, Lisa. The group communication screen 560 may be initiated with or without the contact user. Interfacing with the user buttons 566 for the participant may provide additional information about them, such as name and location, and may provide access to streams or information they have provided to the chat. For example interfacing with the client user' button 566 may swap to their stream view 520 or map view 560, or allow participants to select one or both of those, if those are available. This interface is shown in the context of a client application 502 on a phone, but dispatch may access the group communication on a computer with a monitor that allows more information to be displayed. Accordingly, implementations of this may show the streaming screen 520 or map view screen 560 as picture-in-picture or in separate windows or areas so that dispatch (or a computer user) can see all relevant information at once. The add button 562 may allow the contact user to add other users that may have important information, such as the client user's family members, or may allow the contact user to upload files or other information to provide same to emergency dispatch. The communication log may track the history of the communication between the participants, and may include icons for files and other information that are submitted during the group communication. It may be archived after the session is completed. A messaging area 64 may allow a contact user to compose and edit messages before submitting them, and a send button 65 may allow the user to transmit a composed message once it is ready. Persons of skill in the art will recognize that all of the functionality of modern day chat rooms and text messaging systems may be included in the group communication screen within the scope of the disclosed concepts.

The disclosed concepts provide the following safety, privacy, and compliance features:
Granular Consent: Users whitelist contacts and select conditions (time of day, places, risk score thresholds).
Data Minimization: Share least information necessary until escalation thresholds are met.
Duress Controls: Silent/disguised notifications to avoid endangering the subject.
Security: End-to-end encryption where feasible; short-lived access tokens; strict role-based access; audit trails.

The disclosed concepts may utilize various communication protocols, including but not limited to SMS, MMS, RCS via carrier gateways, in-app/IP messaging, SIP/VOIP, secure web chat link for PSAP/GSOC participation, and other protocols known in the art or to be developed. Connectivity with dispatch services may be obtained through poublic PSAP integrators (e.g., NG911/RapidSOS-style), campus security, corporate SOCs, and other protocols known in the industry or to be developed.

If text session creation fails, an auto-initiate an outbound administrative voice call may be initiated and a post-session transcript may be generated for the session.

Where a client user remains unresponsive the system may continue to escalate per policy or user setting, and may eventually unilaterally contact emergency services without the assistance of a contact. It may further keep a log of communication attempts; and proceed to contact dispatch upon reaching a preset threshold.

When a dispatch request has been made, the system may surface templated prompts for dispatcher/agent engagement (e.g., initial reassurance, check-ins at intervals, “emergency confirmed,” “cancel and close,” “no response→dispatch”). Time-based state transitions (e.g., 30-second no-response escalations) may move the flow among safe/anxious/emergency/unresponsive states and enact dispatch via administrative line when thresholds are met.

A stream, as used herein, can be classified as the sharing of video, audio and/or location from a mobile device via the 3RD-I application or other streaming mechanisms like Facetime, Phone Call or Text Messaging.

Some exemplary uses of the disclosed concept may include a travel deviation such as a contact's observation that the subject is dwelling unusually long outside trusted geofence and triggers an on-behalf dispatch. The dispatcher receives address and engages contact in text session; responders navigate to address while contact provides medication info and clothing description. Another may be an incapacitation, where a wearable device indicates a fall with no motion. The contact receives an anomaly prompt and confirms on-behalf dispatch; session streams location to dispatch and/or first responders and contact; subject is added. Another may be a coercion scenario, where a client user's device may indicate a duress code; a safety policy suppresses notifications to the subject, a contact and dispatcher are notified and coordinate until help arrives.

Examples which may require discreet or hidden functionality may include a silent distress signal, where a user sends a coded text (“wrong emoji,” “call me later”) to signal danger without alerting someone nearby. Another may be a client user Not answering calls in unsafe areas, where a contact sees they're stopped in a sketchy spot and unresponsive. Another may be a suspicious detour where a client user's rideshare goes off route and the user goes quiet. A contact who is meeting the user somewhere may see this deviation and initiate an emergency request. Another is a mobile communication distress signal, where a contact sees or hears shouting, threats, or unsafe behavior during a form of mobile communication, such as a phone call, facetime or livestream that shows escalation, and may initiate an on-behalf emergency request on behalf of the client user.

The disclosed concepts may also be used in non-discreet or obvious situations, where it is clear that something is wrong, but the client user either cannot or does not trigger an emergency response for themselves. For example, where there is a medical emergency in a public place, such as a user having an asthma attack, fainting during a walk, having a seizure at a sporting event, if they are communicating with a contact who sees them collapse during their communication, or stops receiving motion or location updates, the contact may trigger an emergency response. Once the response is triggered, the contact can connect with a dispatcher, and provide the client user's location and medical information, and/or share the communication feed with the dispatcher. Similarly, if a user is streaming while driving or traveling in a vehicle, and is involved in an accident on the stream, an authorized contact can initiate a request for emergency services for a client user immediately, and then provide the crash location and context (such as a bike accident, head on collision, air bags deployed, injuries likely, etc.). If a client user is streaming a sporting event, such as a marathon, by streaming their location information to their contacts during the race, and has an incident. Their contacts may see that their location tracker suddenly stops and doesn't move further, they can initiate a request for emergency response, and provide location information and additional details to the emergency dispatch, such as the client user being on his third hour of running the marathon, and potential suffering from The disclosed concepts can also be used in situations where a user can be seen to be in danger while streaming, such as a guest getting violent during a podcast, or a fight starting at a party or bar. The contact may initiate an emergency response and provide context and location information, such as fight at a party, with injuries. The location information and video stream showing the fight can be provided to emergency dispatch.

The disclosed concepts can also be implemented to serve elderly and other at-risk populations. For example when a senior or chronically ill person stops responding while streaming while being transported to a hospital, a family contact can initiate an emergency response and provide the person's medical records and a location or location stream to emergency dispatch. This can be of particular importance in rural areas where the nearest hospital may be a large distance away, and emergency services can meet with the person being transported en route to begin providing medical services during the transportation.

The disclosed concepts may also be used during a vehicle emergency, such as a contact receiving a GPS location and text message or application 2 notification from a client user that their car has broken down on a highway and their phone is about to run out of battery power. The contact can initiate a request for emergency services, and provide them with the client user's location and any contextual information required (tire blow out, smoking engine, etc.).

Embodiments of the disclosed concepts may be implemented by communication via federated channels, such as secure email to SMS gateways or a read-only PSAP web portal. Client user consent to third parties can be implemented via third-party identity wallets, with hardware security keys used for authorization. Machine generated structured summaries (including reason for emergency request, risks and medical information), may be used to accelerate dispatcher intake.

The disclosed concepts enables timely emergency initiation when the subject cannot act, delivers structured, actionable context directly to dispatch and/or first responders, and preserves auditable consent and safety-aware notification policies.

FIG. 22 illustrates a trip streaming screen 710 on a mobile application 702 in accordance with the disclosed concepts. The trip streaming screen 710 may include a primary stream 711, which may be filmed with a self-facing camera. It may further include second, forward facing stream 712 when dual-camera streaming is activated. The forward-facing stream 712 may be displayed in the mobile application in picture-in-picture mode, overlaying a corner of the primary stream 711. A viewer count button 713 may be provided which may provide the user with information as to who is viewing the stream when the user interacts with the button 713. A chat button 714 may further be provided to allow the user to communicate with the viewers, by opening a chat window or by overlaying the chat communications over the bottom of the primary stream 711. A map and route display area 715 may be provided, which may display the user's current location on a map, and next turn information. The map display area 715 may further show a planned route 716 for the trip, and an actual route 717. The map display area 715 may further include controls 719 a, b, c, d, which may include trip controls 719a, sound controls 719b, trip notes 719c, and an information button 719d. The trip controls 719a may allow a user to modify the destination or planned route for the trip. The trip notes control 719c may allow the user to memorialize notes from the trip, initiate a trip stream, initiate an emergency response. For example, it may open a window similar to actions popup 541 shown in FIG. 18, allowing a user to begin streaming to all friends, stream to certain squads, initiate a trip stream, or trigger an emergency using an emergency button 529.

When the trigger emergency button 529 is pressed it may open an emergency trigger confirmation popup 526 similar to that shown in FIG. 17 (except for the user instead of for a contact viewing the user's stream), and allow the user to confirm or cancel the emergency using an emergency confirmation button 528 or cancellation button 527. When an emergency is triggered, an emergency trigger response system, as described above may initiate a communication session between the user and emergency dispatch. Emergency dispatch may be provided with the user's stream information, including the primary stream, 711, secondary stream 712, current location data, destination, planned route 716, actual route 717. The actual route may include the geolocation coordinate stream from the user's mobile device. The planned route may be input by the user upon initiating the trip stream, and the planned route may be calculated using mapping services, such as Waze, Google Maps, Apple Maps, Expedia, or the like. Additional information may be provided, such as the user's vehicle information, any accident report data or stream that the vehicle may have collected and/or provided to the user's phone, and the user's emergency medical information packet (medical history, allergies, current medications, emergency contacts, doctors, etc.). If the user is using a ride share application, or if the mobile application is integrated into a ride sharing platform, emergency dispatch may further be provided with information on the ride share driver, including their identity, driver's license, car make and model and license plate, If other contacts or users are traveling with the streaming user, an information packet with their identity and any relevant medical information may also be sent automatically to emergency dispatch. Accordingly, when a client user is streaming in dual-camera mode, with video streams from both the forward-facing and rear-facing camera, both video streams, together with the audio stream, and GPS/location stream can be passed along to emergency services, who can then take appropriate action even without direct input from the client user, who may need to speak cautiously to maintain their safety. Where an emergency is triggered from a trip-mode stream, emergency services may further be provided with destination, planned route, and actual route information, where the actual route information may be from the GPS/location stream.

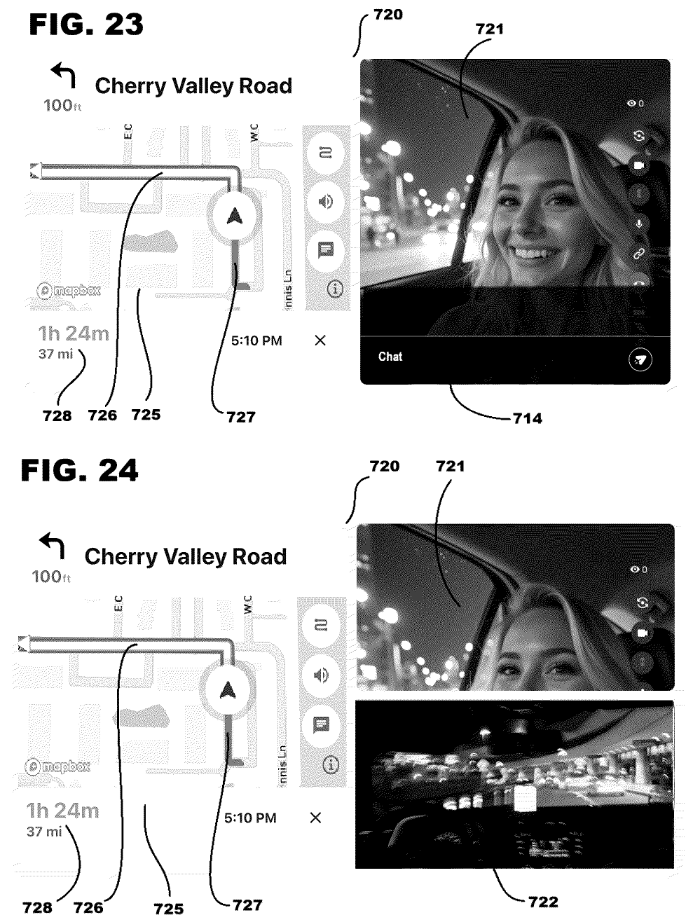

FIGS. 23 & 24 illustrate exemplary desktop application stream view 720, similar to that which may be provided to emergency dispatch or to viewers who are viewing the stream from a desktop computer or laptop instead of using a mobile device. The desktop application stream view 720 may include a primary stream display 721, a secondary stream display 722, and a map and route display 725. The secondary stream may be displayed below the primary stream 721, as shown in FIG. 4, or in a picture-in-picture format, or only one video stream 721, 722 may be displayed at a time, and the viewer may toggle between same. The desktop application stream view 720 may be incorporated into the monitoring system dashboard interface 400 or similar interface, including informational windows 405 and message/chat history 407. The additional information window 405 may include links allowing access to the user, driver and contact information discussed above. The message/chat history may include communications with a monitoring system as well as communications with emergency dispatch. All of the information and the layout of the monitoring system dashboard interface may be provided to emergency dispatch, including any communications prior to escalation to emergency dispatch. Accordingly, in embodiments where a user is streaming in dual-camera mode, using both the forward-facing and rear-facing cameras of their mobile device, emergency services dispatch services may receive both video streams, the audio stream, and the GPS/location stream. Where a trip-mode stream has been engaged by the client user, emergency dispatch may further be provided with a selected destination and a planned route for the trip, and an actual route that may comprise the GPS/location stream.

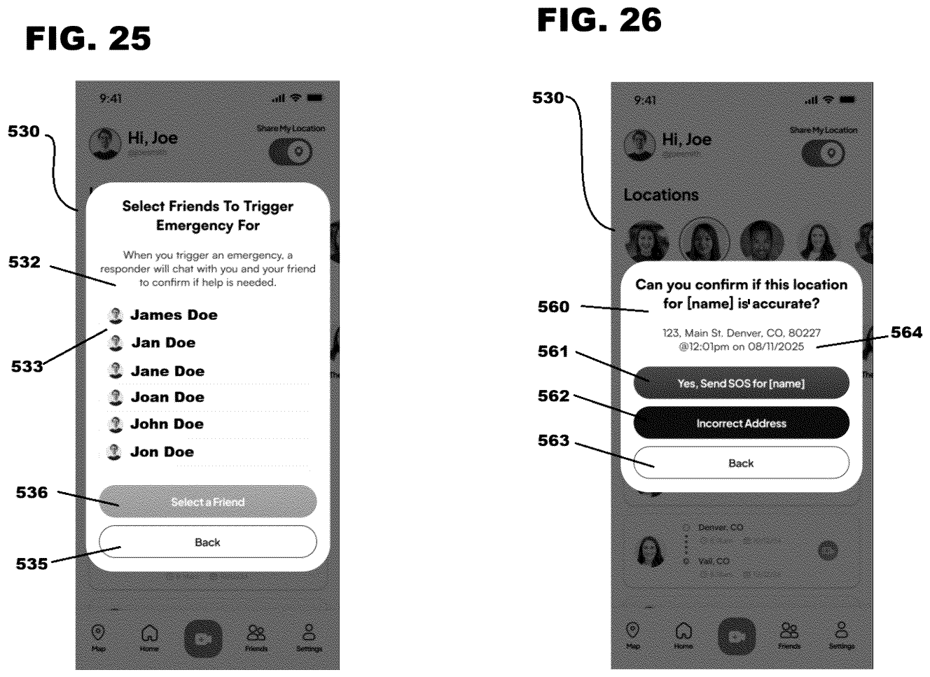

FIG. 25 illustrates a client application 2 contacts screen 530 allowing a contact to trigger an emergency response on behalf of a client user in accordance with the disclosed concepts. When a contact triggers an emergency response on behalf of a client user by hitting the emergency trigger button 528, an emergency confirmation popup 532 may be displayed. This popup 532 may include a listing of contacts 533, a confirmation button 536 and cancellation button 535. The contact user may sue the listing of contacts to select the client user(s)/contacts on whose behalf to trigger the emergency response. The confirmation button may be grayed out and unusable until the user selects one or more contacts/client user(s). Once users are selected, the button may activate, as shown and discussed above with respect to FIG. 18.

FIG. 26 illustrates a client application contacts screen allowing a contact to confirm an address or pinpoint location for an emergency response on behalf of a client user in accordance with the disclosed concepts. Once an emergency is triggered on behalf of a contact or client user, the application may display an address confirmation popup 560. The address confirmation popup 560 may include a confirmation button 561, a change address/location button 562, a cancellation button 563 and an initial address 564. The initial address 564 of the address confirmation popup 560 may be initiated with current location or address information from the client user's device, if available, or with the client users last known location or home address. The initiating user may then select to confirm the initial address 564 as the client users current location by hitting the confirmation button 561. If that address is incorrect, the user may elect to enter another address for the client user by using the change address/location button 562, or may cancel the emergency response request using the cancellation button 563. If the change address button is hit, that may bring up an address selection screen 570.

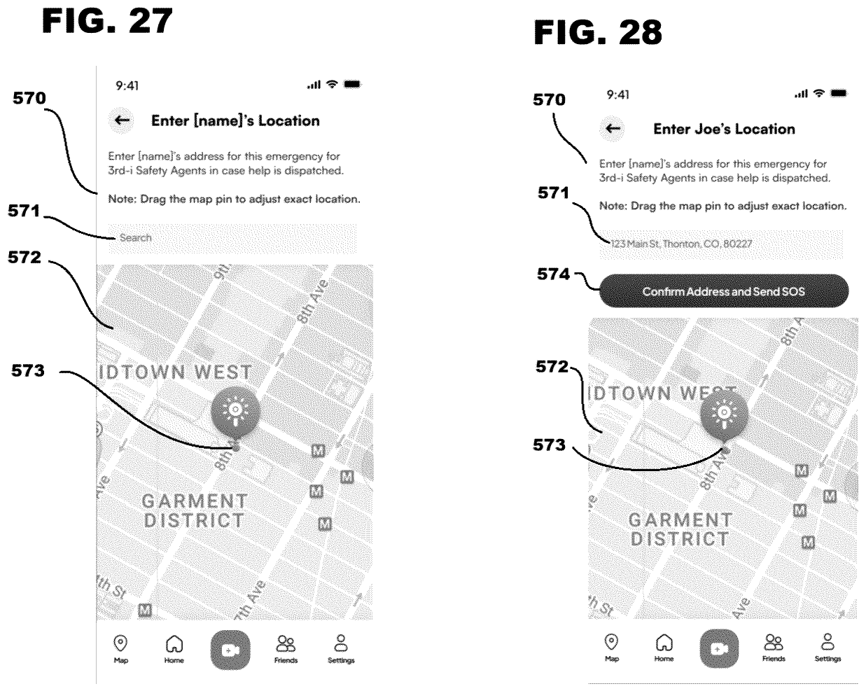

FIG. 27& 28 illustrates an address selection confirmation screen 570 in accordance with the disclosed concepts. The address selection screen 570 may include a search function interface 571, a map 572 and a current location/address tag 573. The user may modify the current location/address tag by dragging and dropping it to a new location on the map, or by using the search interface 571 to search for an address where the client user is known to be. When the search function interface 571 is used, the current location/address tag may be moved to the searched address, and the initiating user may further move the tag by dragging and dropping or refining the search. Once the tag has been moved to a new location, a confirmation button 574 may be presented, as shown in FIG. 28, to allow the user to confirm the new address and initiate the emergency response request. Moving the tag to a new location may select the nearest available address, and may further provide a pinpoint GPS location and/or longitude and latitude location that can be sent along with the streaming information to emergency services dispatch and/or to first responders, or to a group chat with same as described above. The address selection confirmation screen 720 may also be provided to a user initiating their own emergency response so that they can provide accurate current location information in situations where the GPS services on their phone may be disabled or subject to interference.

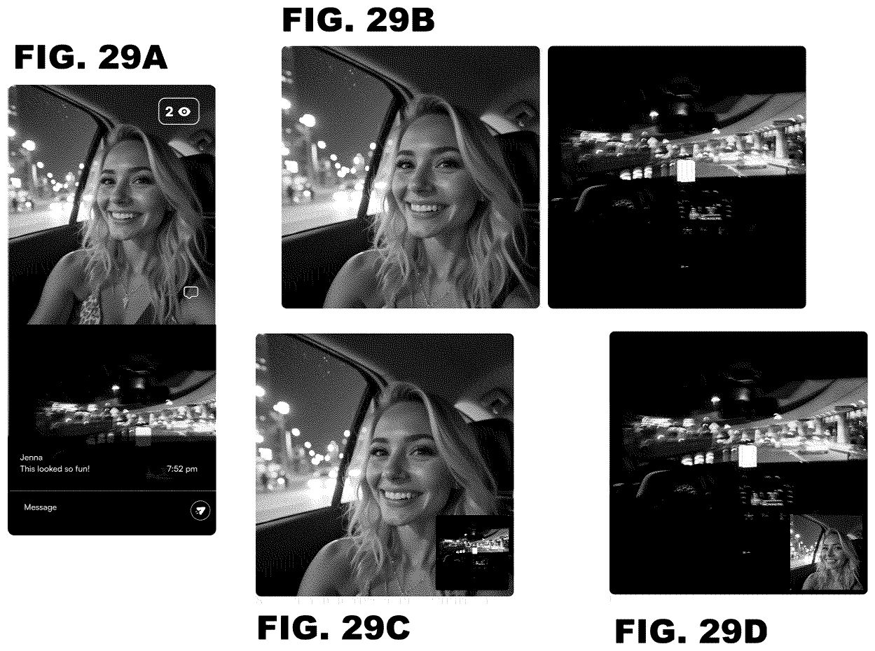

FIGS. 29A-D illustrate different ways of displaying the dual camera streams simultaneously. FIG. 29A illustrates the dual-camera streaming shown on a mobile device with one stream displayed above the other at the same size. FIG. 29B illustrates the dual camera streams displayed side-by-side, as on a desktop or laptop computer, side by side at the same size. FIG. 29C&D illustrate a display of the dual-camera stream in picture-in-picture mode with one stream being displayed larger than the other.

While the invention has been described with reference to specific embodiments and examples, it will be understood by those skilled in the art that various changes may be made and equivalents may be substituted without departing from the scope of the invention. In addition, many modifications may be made to adapt a particular situation, material, composition of matter, method, or process step to the objective, spirit, and scope of the present invention. All such modifications are intended to be within the scope of the claims appended hereto.

We claim:

1. A method for providing information to emergency services dispatch from a user of a mobile communication device having a front-facing camera and a rear-facing camera, a microphone, and a GPS receiver, the method comprising:
providing an application on the mobile communication device capable of receiving an emergency response request input and allowing a user to initiate a trip-mode stream; and
responsive to a first emergency response request input from the user, transmitting an emergency data stream to a remote dispatcher or monitoring center, the emergency data stream comprising:
a first video stream for video images recorded by the front-facing camera of the mobile communication device,
a second video stream for video images recorded by the rear-facing cameras of the mobile communication device,
an audio stream recording of environment audio stream recorded by the microphone of the mobile communication device;
a stream of geolocation coordinates from the GPS receiver of the mobile communication device; and
connecting the user to emergency services dispatch, including providing the emergency data stream to emergency services dispatch to enable direct communication between the user and emergency services dispatch.

2. The method of claim 1 wherein the emergency data stream further comprises trip information, including a destination, a planned route, and an actual route, wherein the actual route comprises at least some of the stream of geolocation coordinates.

3. The method of claim 1 wherein the emergency data stream further comprises the user's emergency medical information packet.

4. The method of claim 1 wherein the emergency data stream further comprises the user's vehicle information.

5. The method of claim 4 wherein the vehicle information comprises a vehicle make, vehicle model or information streamed from the vehicle.

6. The method of claim 1 further comprising providing the user with a location confirmation screen where they can provide updated current location information.

7. The method of claim 1 wherein the emergency data stream further comprises a ride share packet.

8. The method of claim 7 wherein the ride share packet includes information selected from the group of the driver identity, driver's license number, car make, car model and license plate.

9. The method of claim 7 wherein the emergency data stream further comprises a companion information packet.

10. The method of claim 9 wherein the companion information packet comprises an identity and medical packet for a contact that is on the trip with the user.

11. A system for managing an emergency response request for a user of a mobile communication device having at least one camera, a microphone, and a GPS receiver, the method comprising:
an application on the device capable of receiving an emergency services request input from the user and allowing the user to initiate a stream; and
a monitoring service capable of communicating with the application;
wherein the monitoring service receives a first stream from the user comprising:
a first video stream for video images recorded the mobile communication device,
an audio stream recording of environment audio stream recorded by the microphone of the mobile communication device,
a stream of geolocation coordinates from the GPS receiver of the mobile communication device,
wherein responsive to a first emergency services request input from the user during the first stream, the monitoring service connects the user to emergency services dispatch to enable direct communication between the user and the emergency services dispatch and provides an emergency data stream to the emergency services dispatch, the emergency data stream comprising the first video stream, the audio stream, and the stream of geolocation coordinates.

12. The system of claim 11 wherein the first stream is a trip-mode stream and the emergency data stream further comprises trip information, including a destination, a planned route, and an actual route, wherein the actual route comprises the stream of geolocation coordinates.

13. The system of claim 11 wherein the emergency data stream further comprises the user's emergency medical information packet.

14. The system of claim 11 wherein the emergency data stream further comprises the user's vehicle information.

15. The system of claim 14 wherein the vehicle information comprises a vehicle make, vehicle model, or information streamed from the vehicle.

16. The system of claim 11 wherein the application further provides the user with a location confirmation screen where they can provide updated current location information.

17. The system of claim 11 wherein the emergency data stream further comprises a ride share packet comprising information selected from the group of the driver identity, driver's license number, car make, car model and license plate.

18. The system of claim 11 wherein the first stream further comprises a second video stream, such that the first video stream is captured by a forward-facing camera of the at least one camera on the mobile communications device and the second video stream is captured by a rear-facing camera of the at least one camera on the mobile communications device.

19. The system of claim 11 wherein the emergency data stream further comprises a companion information packet comprising an identity and medical packet for a contact that is on the trip with the user.

20. A method for providing information to emergency services dispatch from a user of a mobile communication device having at least one camera, a microphone, and a GPS receiver, the method comprising:
providing an application on the mobile communication device capable of receiving an emergency response request input and allowing a user to initiate a stream; and
responsive to a first emergency response request input from the user, connecting the user to emergency services dispatch, including providing an emergency data stream to emergency services dispatch, to enable direct communication between the user and emergency services dispatch;
wherein the emergency data stream comprises:
a first video stream for video images recorded a first camera of the at least one camera of the mobile communication device,
an audio stream recording of environment audio stream recorded by the microphone of the mobile communication device;
a stream of geolocation coordinates from the GPS receiver of the mobile communication device.
